(19) United States
(12) Patent Application Publication
(10) Pub. No.: US 2017/0236100 A1
(43) Pub. Date: Aug. 17, 2017

(54) VEHICLE MAINTENANCE SYSTEMS AND METHODS

(71) Applicants: Shafagh Bayat, San Clemente, CA (US); Jeffrey Potter, San Clemente, CA (US)

(72) Inventors: Shafagh Bayat, San Clemente, CA (US); Jeffrey Potter, San Clemente, CA (US)

(21) Appl. No.: 15/487,385

(22) Filed: Apr. 13, 2017

Related U.S. Application Data
(60) Provisional application No. 62/295,007, filed on Feb. 13, 2016.

(51) Int. Cl. G06Q 10/00; G07C 5/00

(52) U.S. Cl. CPC G06Q 10/20; G07C 5/006

(57) ABSTRACT

The present disclosure is directed to systems and methods for receiving, via a computing device, registration information from a requester that is registering with a vehicle maintenance system; allowing, via the computing device, the addition of at least one vehicle requiring a service task; for the at least one added vehicle, accepting, via the computing device, a selection of a service task; accepting, via the computing device, attributes relevant to the selected service task to form a request; sending out the request to servicers, via the computing device, within a predetermined distance; receiving, via the computing device, quotes from servicers who respond to the request; displaying the quotes to the requester via a display device of the computing device; receiving, via the computing device, a selection of a quote from a servicer; and scheduling, via the computing device, a service task with the selected servicer.

### CROSS REFERENCE TO RELATED APPLICATIONS

The present application claims the benefit of U.S. Provisional Application Ser. No. 62/295,007 entitled “Vehicle Maintenance Systems and Methods” filed on Feb. 13, 2016, the entirety of which is herein incorporated by reference.

### TECHNICAL FIELD

The present disclosure generally relates to computer hardware-based systems and methods, software-based systems and methods, devices, and software applications that can be implemented and used on a wide array of devices, including mobile devices using a mobile software platform. More specifically, the present disclosure relates to communication methods to request, schedule, organize and deploy vehicle servicemen, mechanics or technicians to provide maintenance for, or more specifically, change or renew the motor oil and/or oil filters or provide any type of maintenance service to vehicles, including automobiles, seacraft, aircraft and others, that may belong to a person or a business.

### BACKGROUND

Currently, obtaining an oil change for a vehicle is a cumbersome process that requires planning in advance and waiting. Therefore, there does not exist any way to conveniently allow a user to schedule and perform maintenance tasks, such as oil changes or oil filter changes (as well as brake changes, tire rotations, light changes, fueling) on their vehicle. Vendors and servicemen also have to wait to be contacted for service, so current ways to schedule maintenance services on vehicles are inefficient and wasteful. It is also cumbersome and time-consuming for a user to schedule an appointment with a car maintenance garage or the service department of a car dealer, and then drive the car to the location to have the maintenance task performed. Moreover, users often experience delay in scheduling the maintenance task due to over-booking and overflow of appointments. Even during the performance of the maintenance task, the user often has to wait around until the completion of the task. Therefore, a convenient software application that can efficiently and conveniently manage the performance of vehicle maintenance tasks would be preferred.

### SUMMARY

Provided is a method for receiving, via a computing device, registration information from a requester that is registering with a vehicle maintenance system; allowing, via the computing device, the addition of at least one vehicle requiring a service task; for the at least one added vehicle, accepting, via the computing device, a selection of a service task; accepting, via the computing device, attributes relevant to the selected service task to form a request; sending out the request to servicers, via the computing device, within a predetermined distance; receiving, via the computing device, quotes from servicers who respond to the request; displaying the quotes to the requester via a display device of the computing device; receiving, via the computing device, a selection of a quote from a servicer; and scheduling, via the computing device, a service task with the selected servicer.

Provided is also a method for receiving, via a computing device, registration information from a servicer that is registering with a vehicle maintenance system; allowing, via the computing device, the viewing of requests from at least one requester by servicers within a predetermined distance; receiving, via the computing device, a request from a requester within the predetermined distance of the servicer; displaying, via a display device of the computing device, the request for a service task having attributes to the servicer; allowing, via the computing device, the servicer to respond to the request with a quote within a predetermined time; notifying, via the computing device, the servicer that the quote has been accepted; and scheduling, via the computing device, a service task with the servicer and the requester.

Provided also is a system for managing and scheduling service tasks for vehicles, comprising: scheduling hardware circuitry coupled to a database; at least one requester device; and at least one servicer device, wherein the scheduling hardware circuitry, the at least one requester device and the at least one servicer device are coupled to the Internet.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIGS. 1A-1B show a login screen according to at least one aspect of the present disclosure.

FIG. 2 shows a forgot password screen according to at least one aspect of the present disclosure.

FIG. 3 shows a reset password screen according to at least one aspect of the present disclosure.

FIG. 4 shows a first register screen according to at least one aspect of the present disclosure.

FIG. 5 shows a second register screen according to at least one aspect of the present disclosure.

FIG. 6 shows a select vehicle type screen of the second register screen according to at least one aspect of the present disclosure.

FIGS. 7A-7B show a third register screen according to at least one aspect of the present disclosure.

FIG. 8 shows a fourth register screen according to at least one aspect of the present disclosure.

FIG. 9 shows a thank you screen according to at least one aspect of the present disclosure.

FIGS. 10A-10C show various home screens according to at least one aspect of the present disclosure.

FIGS. 11A-11E show various vehicle profile screens according to at least one aspect of the present disclosure.

FIG. 12 shows a request pending screen according to at least one aspect of the present disclosure.

FIG. 13 shows a cancel request screen according to at least one aspect of the present disclosure.

FIG. 14 shows an editing mode of a vehicle profile screen according to at least one aspect of the present disclosure.

FIG. 15 shows a photo select screen of an editing mode of a vehicle profile screen according to at least one aspect of the present disclosure.

FIG. 16 shows a notification screen according to at least one aspect of the present disclosure.

FIGS. 17A-17D show various marketplace screens according to at least one aspect of the present disclosure.

FIGS. 18A-18B show various servicer screens according to at least one aspect of the present disclosure.

FIGS. 19A-19D show various job detail screens according to at least one aspect of the present disclosure.

FIG. 20 shows a requester menu according to at least one aspect of the present disclosure.

FIGS. 21A-21B show job history screens according to at least one aspect of the present disclosure.

FIGS. 22A-22B show job board screens according to at least one aspect of the present disclosure.

FIGS. 23A-23B show bid screens according to at least one aspect of the present disclosure.

FIG. 24 shows a billing information screen according to at least one aspect of the present disclosure.

FIG. 25 shows a structural hardware network diagram according to at least one aspect of the present disclosure.

FIG. 26 shows a process flow according to at least one aspect of the present disclosure.

FIG. 27 shows another process flow according to at least one aspect of the present disclosure.

The attached figures show various screenshots of an application for vehicle maintenance systems and methods, according to aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The development of the mobile smart phone in relation to applications or “apps” allows the creation of a method to communicate, schedule, organize and deploy people globally to any location in the world to change another person(s)' or business(es)' fleet of vehicles motor oil and oil filter, or other maintenance tasks such as brake changes. Conventionally, a person or a business, or an entity with a fleet of vehicles would have to transport or drive their vehicles to a mechanic, car dealership, or auto shop to have their oil and/or oil filter changed. The problem the disclosed method solves is allowing anyone who is skilled in the area of changing a vehicle's motor oil and the oil filter for any car or any vehicle(s) available today, or newer models released in the future, can go out to the requester(s) or fleet owners of these vehicles, to change their motor oil and oil filter on the spot, in real-time. This is done with software for communicating through a mobile device or smart phone. This method resolves scheduling and busy schedule conflicts a person or business may have to drive to a mechanic, dealership, technician or auto shop. This also applies to any vehicles or any transportation device requiring service or fuel such as hybrid vehicles, full electric vehicles, boats, motorcycles, electric bikes, analog bikes, motorcycles, mo-peds, Segways, drones, helicopters, all sorts of planes, and so on.

The provided method also resolves logistics issues by allowing a requester(s) of motor oil and oil filter changes to choose where and when they want any auto maintenance service(s) to take place, anywhere in the world. It also resolves pricing issues through the implementation of a quote system revealing a list of prices provided by numerous serviceman and/or technicians to the person(s) or business(s) requesting the oil change, thus giving users a more competitive and realistic range of prices to choose from. It resolves the marketing, identifying, and managing of customers for serviceman, mechanic(s), technician(s) or businesses that face the problem of effectively communicating, scheduling, organizing and deploying their services on a global scale to people who need and oil/filter change, or other maintenance tasks performed on their vehicles. The disclosed software application does this easily, efficiently, and promptly through a personal mobile device or smart phone device which a user has access to at any time.

The invention is used by downloading and installing the application onto your smart phone or mobile device. Once the application is installed on your device, you must register as a user who will be requesting to have their vehicle(s) motor oil and oil filter changed. You can also register as a vehicle serviceman, mechanic or technician who will be receiving requests to change vehicle motor oil and oil filter for customers mobile.

Once a person(s) or business(s) or vehicle fleet owner is registered, then they can request an oil change for one or more vehicles by choosing their vehicle make, model, year made, date and time of service. They must also input the location where the car will be located for service, the mileage, license plate number, as well as, any notes needed to provide further details to the serviceman regarding the service. This request is then sent to any registered vehicle serviceman, mechanic(s) or technician(s) in the area.

If the user is a vehicle fleet owner with a large quantity of the same model vehicle, or have different vehicle types, then they can choose to input their requests in bulk. A vehicle serviceman, mechanic(s) or technician(s) can choose to provide service to one or more or fleet of requests. The application automatically uses a scheduling system to organize all scheduled services.

Once a person(s), business(s) or fleet makes a request(s) for service, the request is distributed to vehicle serviceman, mechanics or technicians in the areas where they are notified of the request(s) for an oil change. They have a limited amount of time to analyze, understand and provide an offer or quote to the requester(s) requirements for service. Once a person(s) or business(s) or fleet has received one or more prices, offers or quotes for service, they have the option to accept or reject the service(s). Once a person(s) or business(s) has accepted the service. The job(s) is saved and scheduled on both the requester's side of the application and the vehicle serviceman, mechanic(s) and technician(s) side of the application for access and reference.

A person(s), business(s), vehicle serviceman, mechanic(s) or technician(s) can cancel a request for an oil change within a specific period of time. A person(s) or business(s) will be billed through their original method of payment for services rendered, once the service has been completed. A person(s) or business(s) receives a notification when vehicle serviceman, mechanic(s) or technician(s) are on their way to service, when they start service, the progress of service and when service ends. A person(s) or business(s) receives a notification when vehicle serviceman, mechanic(s) or technician(s) has completed service and payment is processed. A person(s) or business(s) will receive a notification of any promotions, news or updates from our company.

In one implementation, the above-described software can be applied to the management of maintenance tasks for other technologies, such as computer repair. The software may also be any type of code executable on processor(s), or other such components.

Application Logic

The system of the present application works as follows. There are two sides to the system in addition to an administrator (“admin”) and a bug tracking system. The system is composed primarily of two sides: (1) The Requester side and (2) The Serviceman side.

The Requester Side

The application logic (“application”) of the system, which may be circuitry or embedded hardware, is encoded in marketing and business logic. That is, exclusive rights are given to specific mechanics in each city around the world to bid on oil change requests from the general public. The way the requester side of the application works is that the requester submits a request for an oil change for their car or for multiple cars. This request consists of multiple pieces of information which need to be submitted, i.e. the car model, the car make, the year, the mileage and the license plate number (so that the serviceman can identify the car in case here are similar models and colors). The requester also indicates a date and time they want service. Once a request is submitted, a serviceman within 20 miles of the requesters address for an oil change will be notified. Any or all the serviceman within the area will see the request, they will assess the skill, calculate any necessary costs, and respond back with a price (quote). The requester then looks at the quotes they receive and chooses the one they like the most and the job is scheduled.

A sample process flow according to an aspect of the present disclosure is as follows: (1) the requester registers; (2) the requester adds one or more vehicles needing an oil change; (3) the requester enters required attributes for an oil change; (4) the request is sent to servicemen within a predetermined mile radius amount; (5) quotes come back from servicemen; (6) the requester can accept or decline a quote from the quotes that come back; (7) once a quote is accepted, a job is scheduled and noted on both apps; (8) note that from the time a request is made, the serviceman has 15 minutes (or another predetermined time period) to send back a price or the request disappears. All jobs must be scheduled within two days of request (or another predetermined time period). A job may also only be scheduled 2 hours ahead of the current time (or another predetermined time period).

The Serviceman Side

When specific mechanics and auto shops become our affiliates around the world, the system will need to send the requester quotes from the serviceman. Currently, servicemen within 20 miles (or another predetermined distance) of a requester will receive the notification and able to send a quote back. Once the job is accepted by the serviceman, the job is scheduled. When the serviceman taps to begin job, he/she taps finish. The requesters credit card is charged and a notification is sent.

A sample process flow according to an aspect of the present disclosure is as follows: (1) serviceman registers; (2) servicemen within 20 miles (or another predetermined distance) of requester can see/receive request; (3) servicemen have a 15-minute (or another predetermined time period) countdown timer to send a quote back; (4) if a serviceman's quote is accepted, the job or jobs are scheduled; (5) once a serviceman finishes a job, the requesters card is charged.

User Interface

The functionality of the request works according to the figures as shown.

Key Features

Notifications: The system of the present disclosure depends on when users are notified of actions i.e. sending requests, receiving requests and badge notifications. Notifications work in tandem with the application logic, which may be circuitry or hardware.

Servicemen are notified when they receive requests for an oil change. Not only should the phone receive this notification, a design should be implemented to remind the serviceman that requests have come in.

When servicemen send a quote/price back to the requester, a notification is sent to the requester. Not only should the phone receive this notification, but the present disclosure implements a design to remind the requester that quotes have come back and are pending acceptance or rejection.

The “app” icon for both the requester and the serviceman should also have a count at the corner for incoming requests, as described further in the figures.

The requester should be notified when: (i) a job has started and ended, and (ii) when their card is charged.

Serviceman should also be notified when they get paid through the app.

Colors, fonts, layout, real estate and efficiency: The design of the app also applies a unique perspective of user flow, actions, call to actions, and response time. The design also uses a high resolution with no distortions or inefficiencies, a consistent color scheme, font, and a cohesive graphic user interface (GUI) environment to streamline productivity and efficiency. This consistent design also enables the most efficient use of the app. As operating systems become updated, backups of files are kept on a cloud server and are automatically updated periodically.

From here on forth, a user of the vehicle maintenance system (“system”) which also can be referred to as the application (or “app”) will be references as a “requester” and a service person who provides vehicle maintenance services to a requester can be referred to as a “servicer.” The following screens may be displayed on any display device, any computer with a display or on any screen, such as a smart phone device, tablet device, computer monitor, flat screen television, watch or any other display.

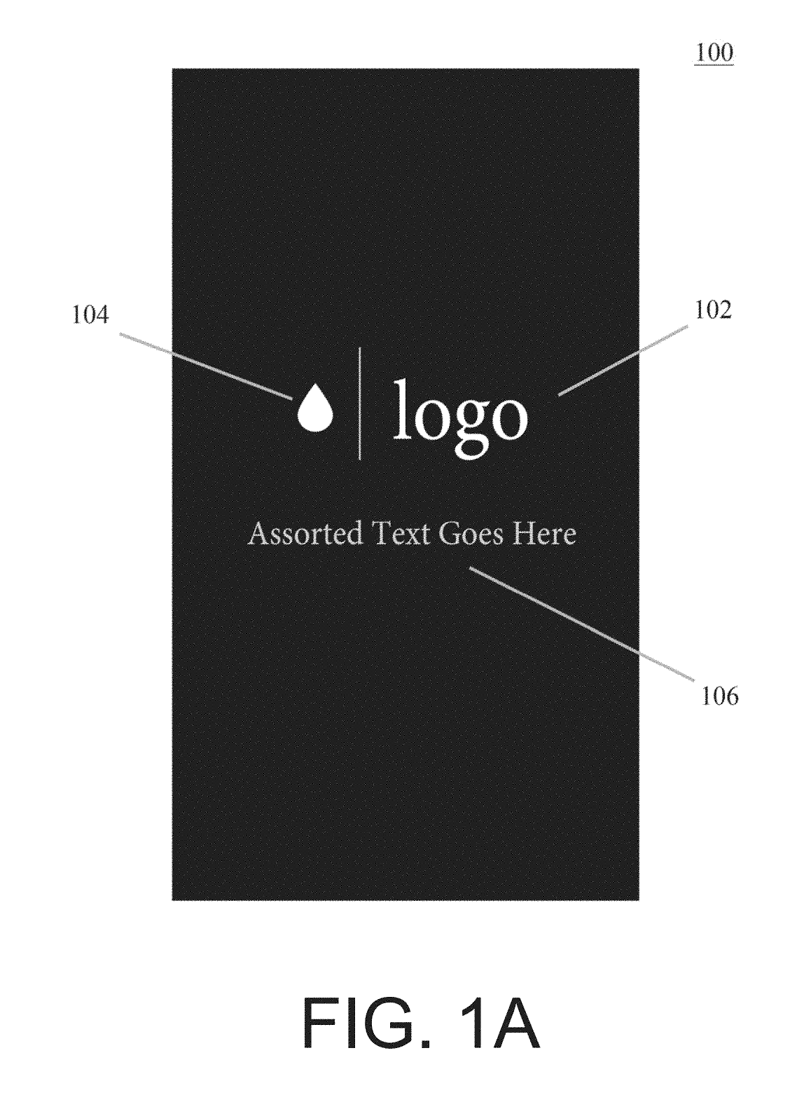

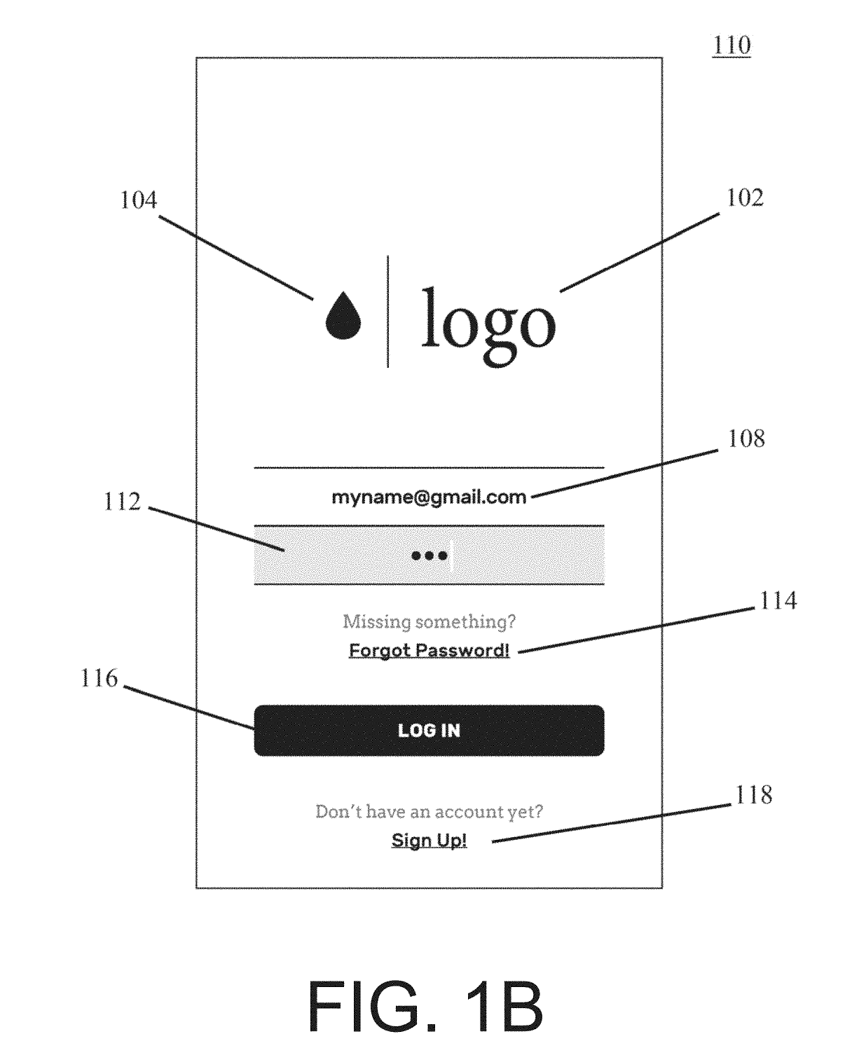

FIGS. 1A-1B show a splash screen 100 and a login screen 110 according to at least one aspect of the present disclosure. Splash screen 100 has a graphical logo 104, text logo 102 and assorted text 106 that may be a part of the logo of the app or system. Login screen 110 also has the same logos 102 and 104, but also features the email of the requester 108 and a password field 112 so that a requester can login to his or her account. Login screen 110 also has a forgot password link 114 so that the requester can request a hint for their current password or reset their password entirely. Login button 116 allows the requester to login to the app. Sign up link 118 allows the requester to sign up for an account with the app.

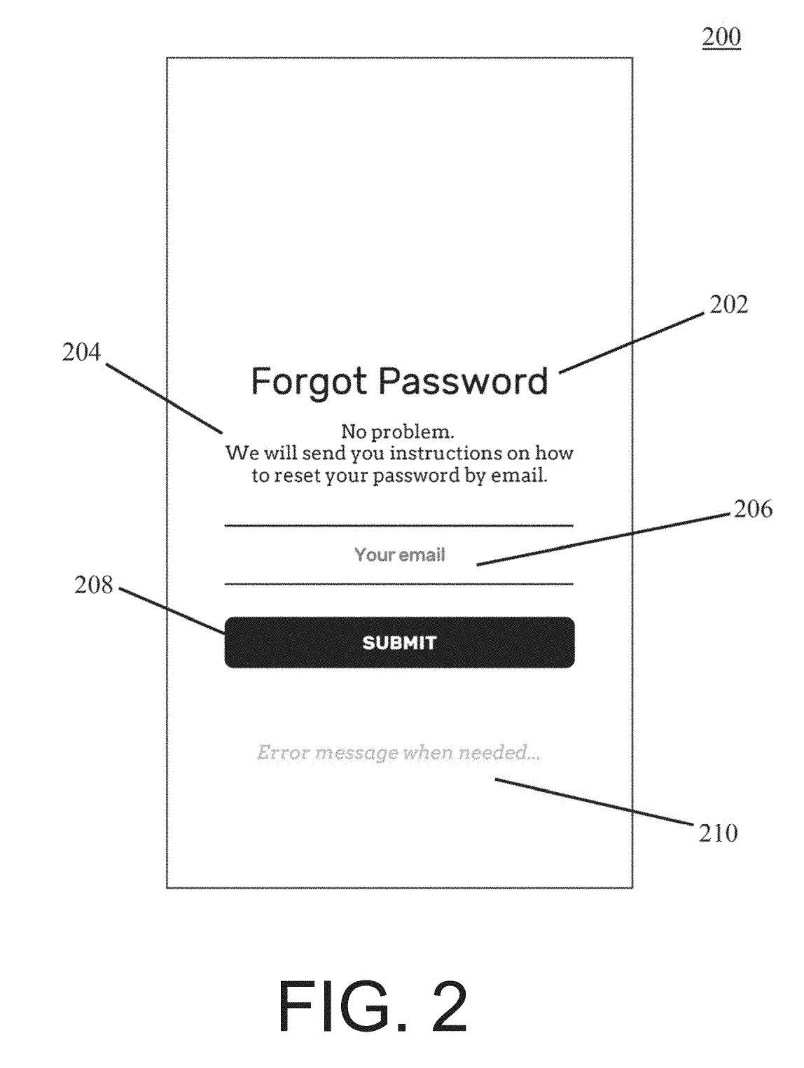

FIG. 2 shows a forgot password screen 200 according to at least one aspect of the present disclosure. Forgot password screen 200 has a forgot password text 202, instruction text 204, email field 206, submit button 208 and error message 210. The requester inputs his or her email in the email field 206 and then clicks the submit button 208. Error message 210 can notify the requester if an incorrect email has been input, for example.

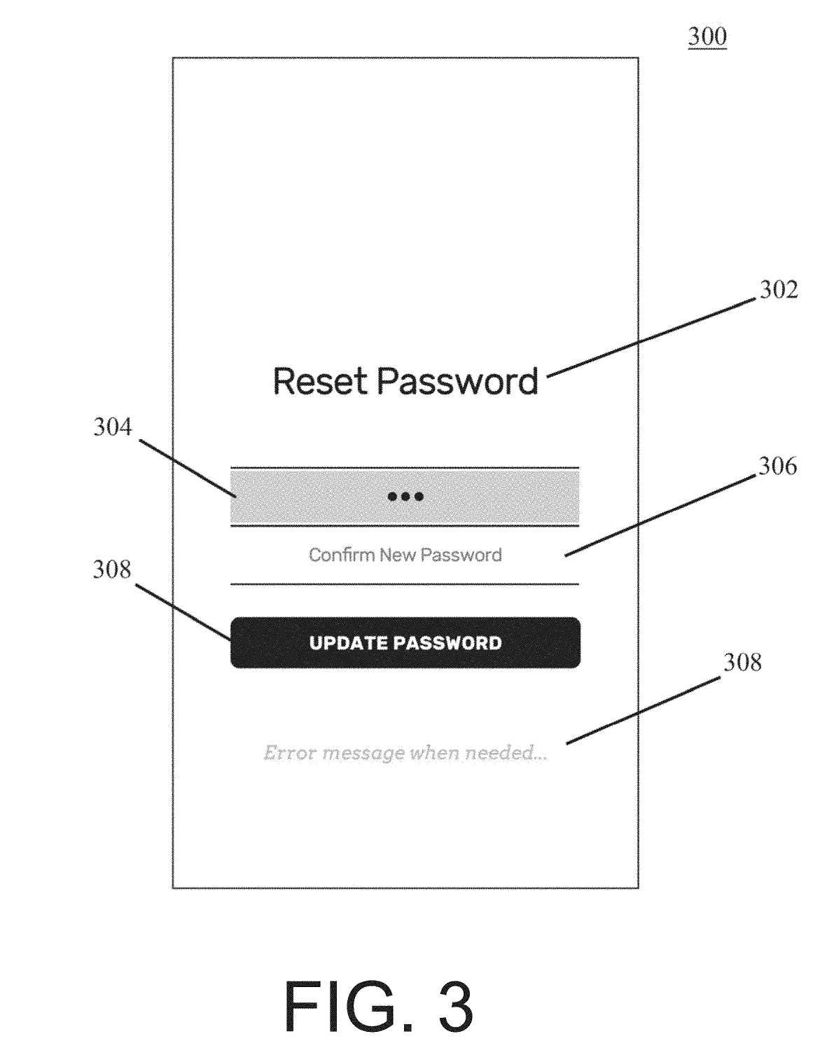

FIG. 3 shows a reset password screen 300 according to at least one aspect of the present disclosure. Reset password screen 300 contains reset password text 302, new password field 304, confirm new password field 306 and update password button 308. Once the requester enters his or her new password in new password field 304, they must confirm it by typing it again into new password field 306 and then click the update password 308 button.

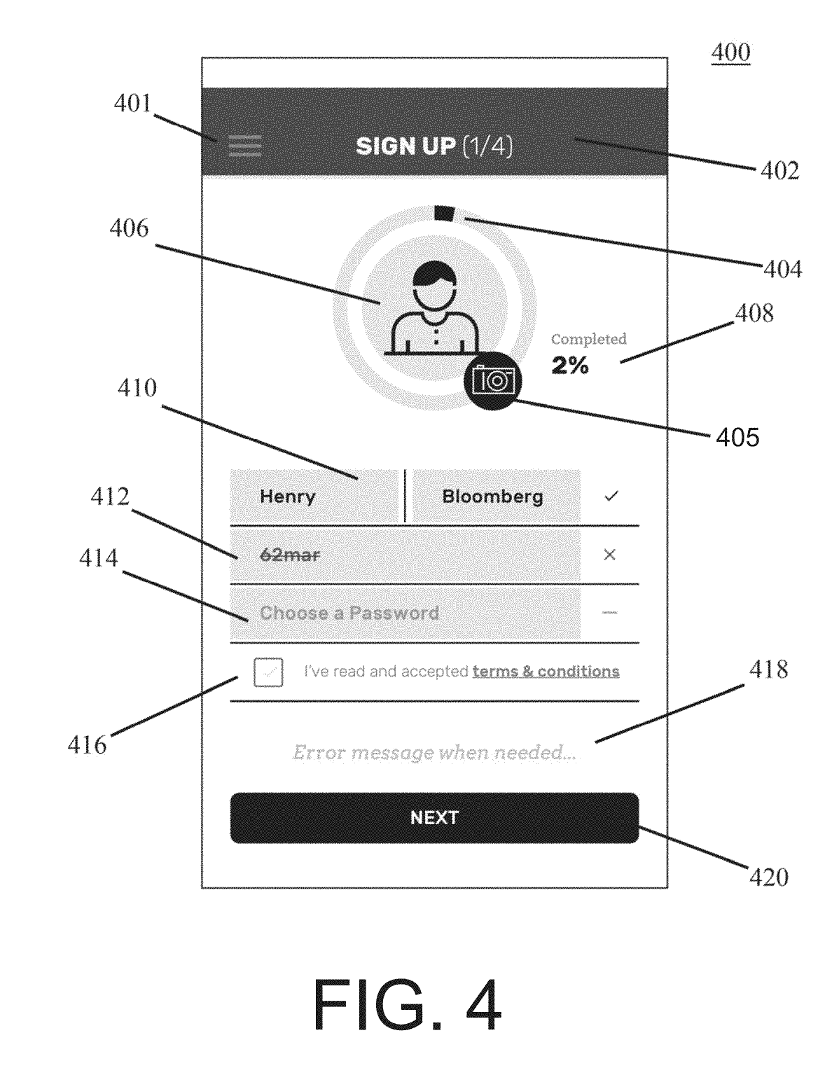

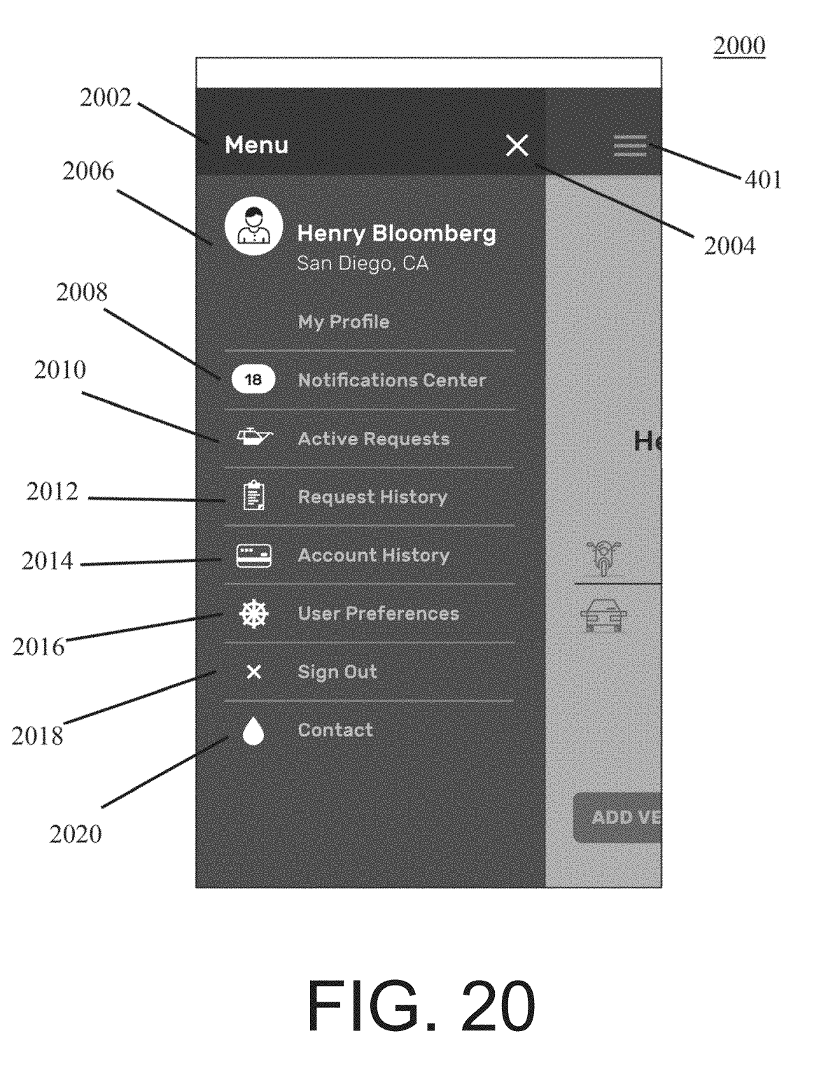

FIG. 4 shows a first register screen 400 according to at least one aspect of the present disclosure. First register screen 400 has a menu tab icon 401 (that leads to FIG. 20 when clicked), progress text 402 that shows you how far a requester is in the registration process, requester profile photo 406, progress bar 404, completed percentage 408, upload photo icon 405, name fields 410, birth date field 412, password field 414, terms and conditions checkbox 416, error message 418 and next button 420. The requester enters all the information into fields 410, 412, 414 and clicks 416 if he or she has read the terms and conditions in order to begin registration as a requester or user of the app. The requester can also upload a profile picture by clicking on the upload photo icon 405, which appears in the requester profile photo 406. The progress bar 404 tells the requester how far along they are in the registration process, and the completed percentage does the same thing.

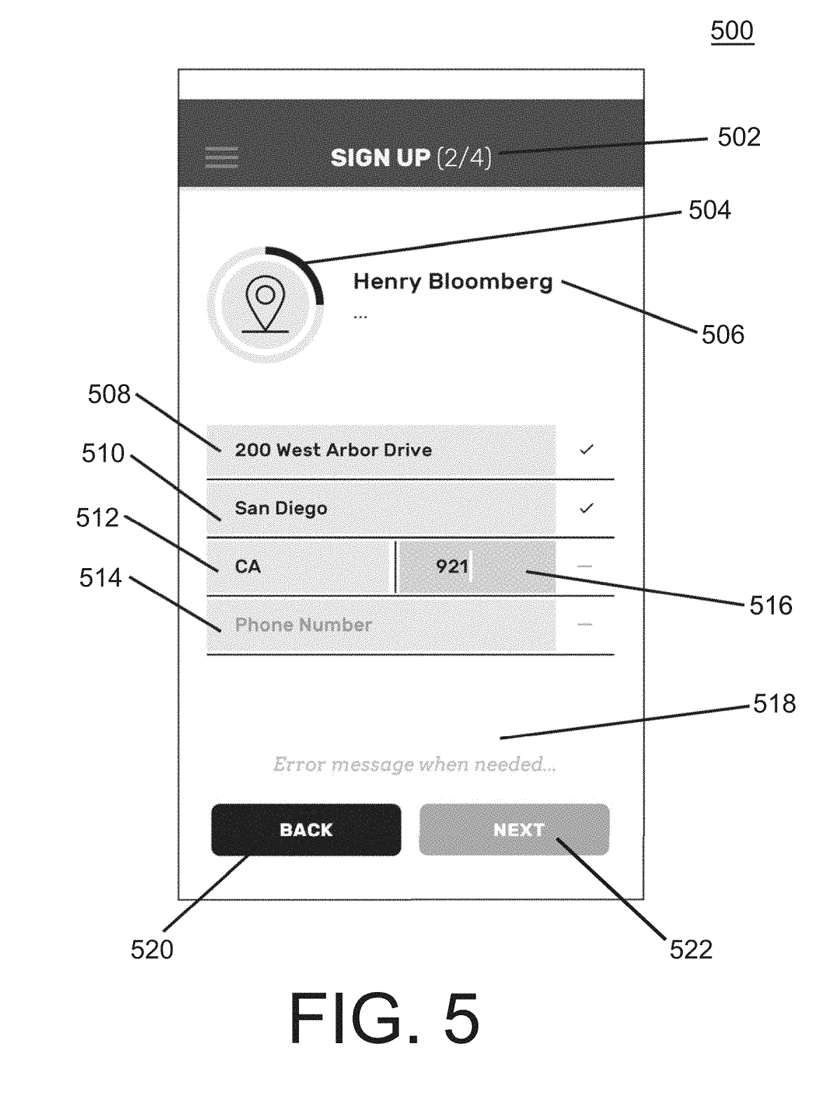

FIG. 5 shows a second register screen 500 according to at least one aspect of the present disclosure. Second register screen 500 shows progress text 502, a progress bar 504 that is more advanced, a requester name 506, address fields 508 (address), 510 (city), 512 (state) and 516 (zipcode), as well as phone number field 514. Once the requester has input all the information into the aforementioned fields, he or she can click the back button 520 to go back and change/remove information previously entered or click next button 522 to go onto the next stage in the registration process. The error message 518 may show up if the requester entered incorrect information into any of the fields.

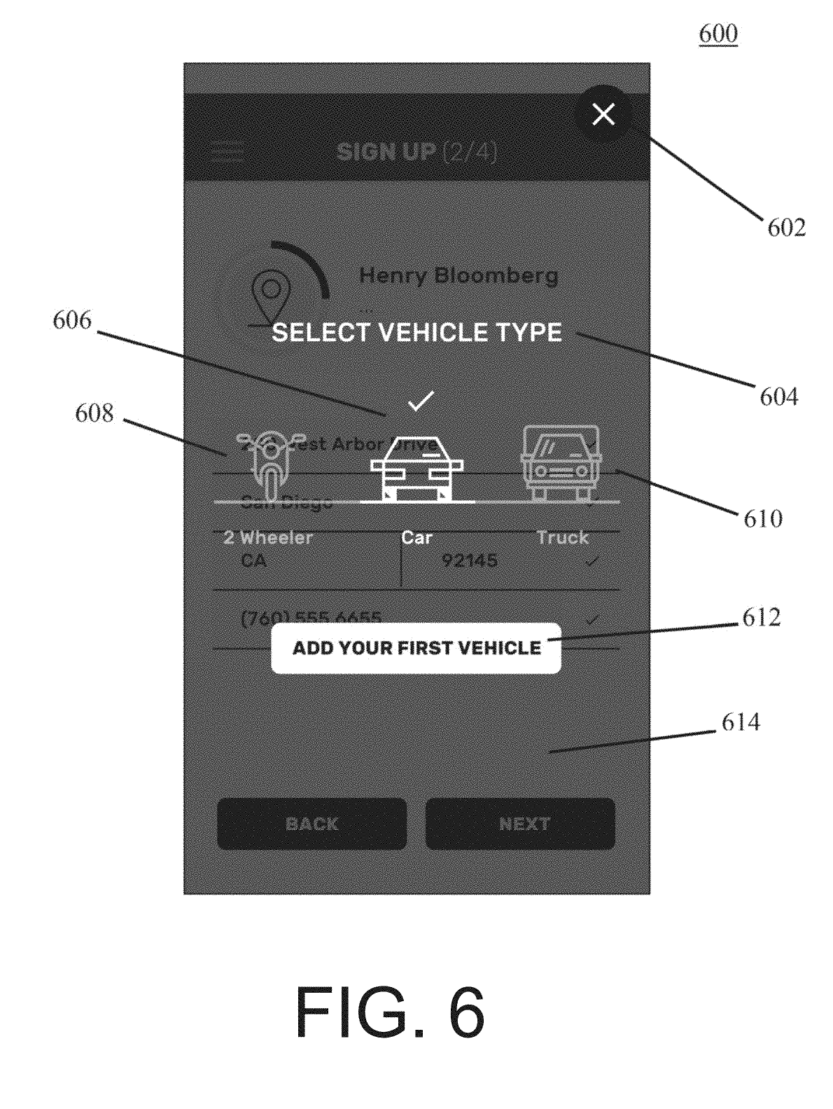

FIG. 6 shows a select vehicle type screen 600 of the second register screen according to at least one aspect of the present disclosure. The select vehicle type screen 600 shows a close button 602 allowing the requester to close out of the screen 600, select vehicle type text 604, currently selected vehicle icon 606 and other vehicle type icons 608 (shown as a 2 wheeler) and 610 (shown as a truck). The types of vehicles include, and are not limited to, boats, motorcycles, planes e.g. helicopters, and other vehicles. Once the user selects their vehicle type as the selected vehicle icon 606, they then click add your first vehicle button 612 in order to advance to the next stage in the registration process.

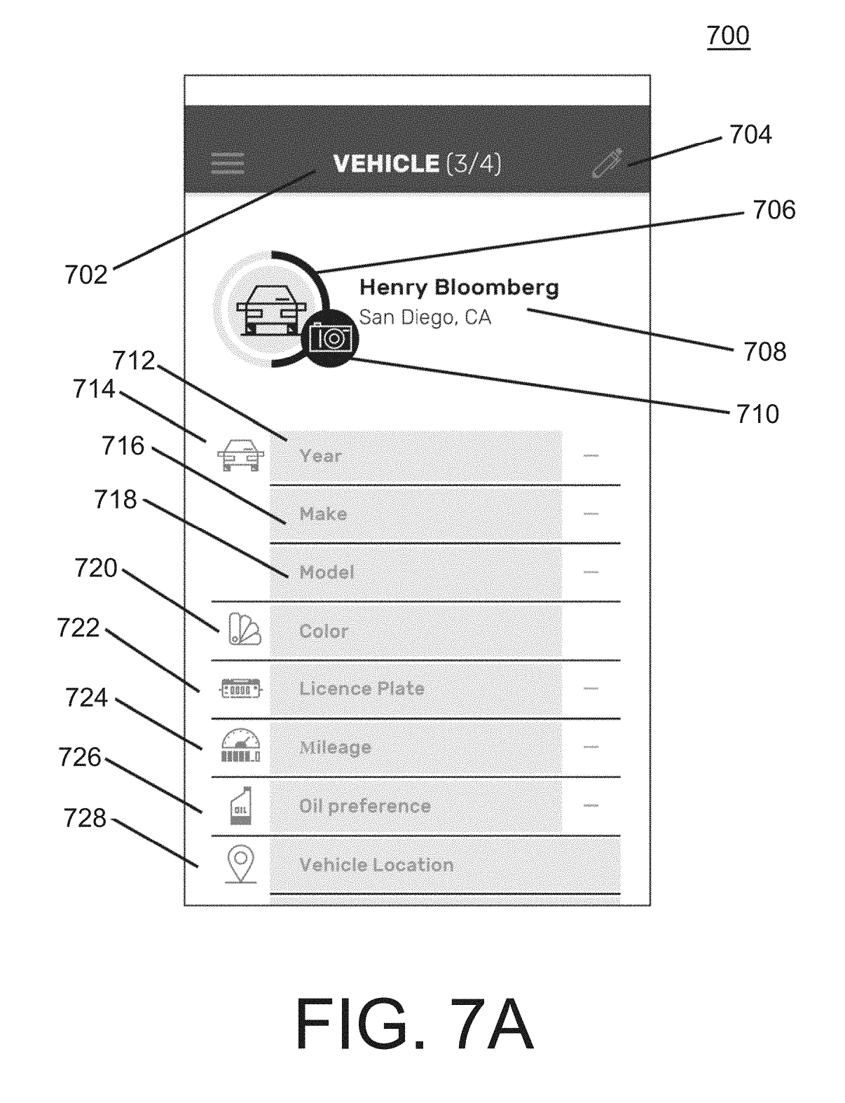

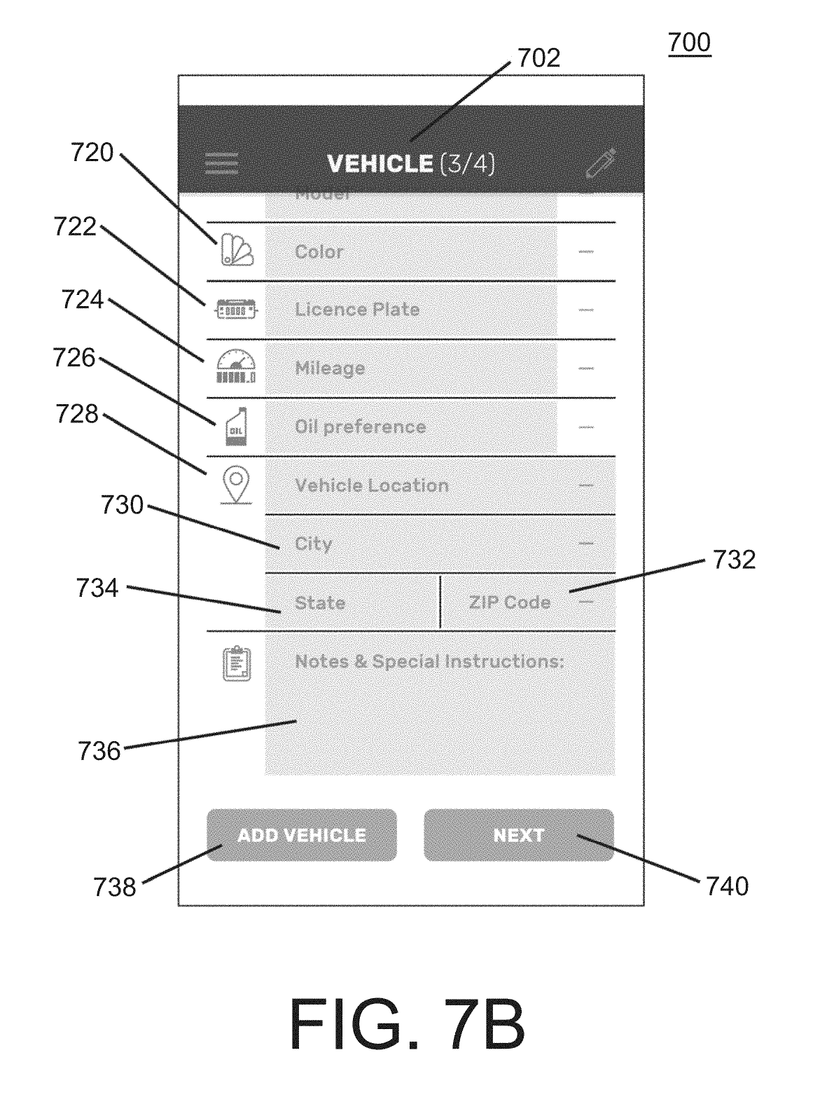

FIGS. 7A-7B show a third register screen according to at least one aspect of the present disclosure. Third register screen 700 shows progress text 702, edit pen icon 704 (that allows the requester to edit the entered information), progress bar 706 that is slightly farther along compared to the last register screen, upload photo icon 710 (to upload a profile photo) and the following fields for the selected vehicle: vehicle icon 714, vehicle year 712, vehicle make 716, vehicle model 718, vehicle color 720, license plate 722, mileage 724, oil preference 726 and vehicle location 728. The vehicle icon 714 represents the type of vehicle the selected vehicle to be added is (here, a car), and the other fields allow the requester to specify detailed information about their vehicle and are relatively self-explanatory. Screen 750 is the third register screen scrolled down a bit more, further showing the city 730, state 734 and zip code 732 fields of the vehicle location 728 data, as well as a notes and special instructions field 736 where the requester can put in any notes or special instructions. The add vehicle 738 button adds the vehicle to the app's database when clicked, and the next button 740 goes onto the next screen or next phase of the registration process when clicked.

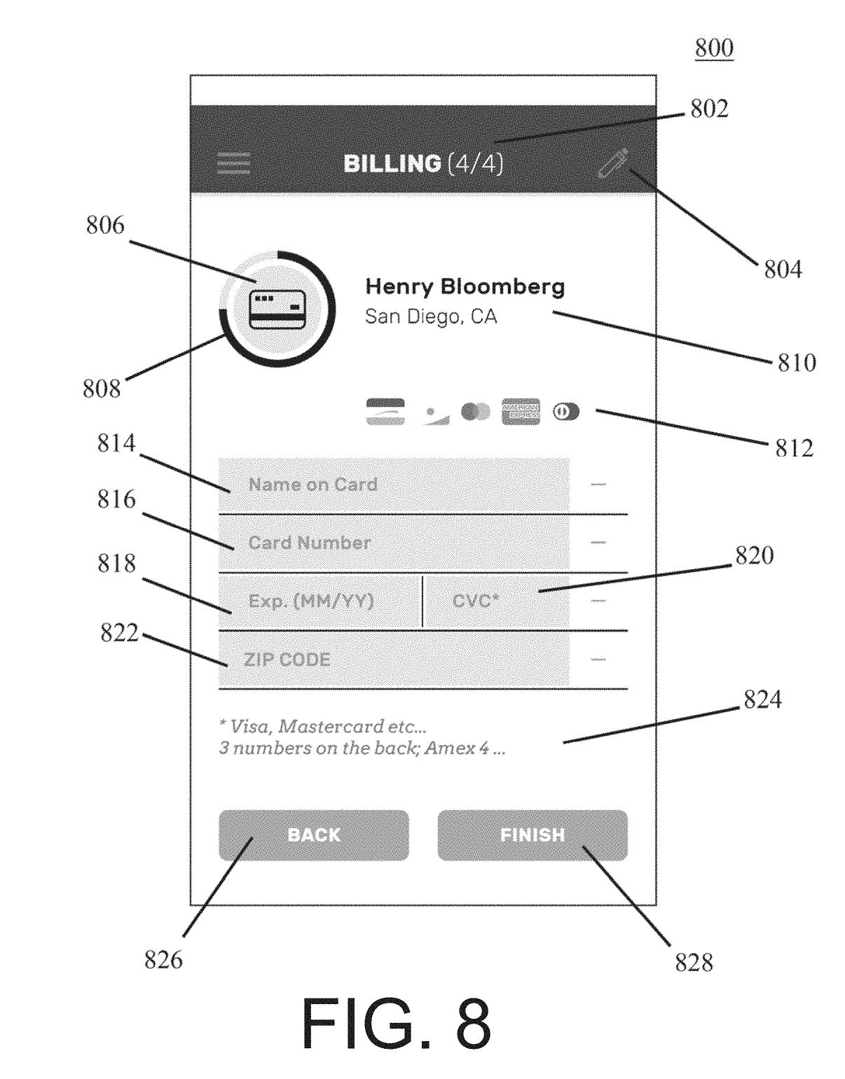

FIG. 8 shows a fourth register screen 800 according to at least one aspect of the present disclosure. Fourth register screen 800 includes billing text 802, pen edit icon 804 (that allows the requester to edit any of the information entered here), card icon 806, progress bar 808, name and location 810 of the requester, accepted credit card type list 812, name on card field 814, card number field 816, expiration date field 818, CVC field 820, and zip code 822. Help message 824 explains which numbers are to be input where (e.g., instructions on which digits are the CVC numbers). Once the requester has entered the relevant information about his or her credit card, they can be billed and be registered to the app. The back button 826 takes them back to previous screens to change/edit information and the finish button 828, when clicked, finishes the process and allows the user to register as a requester.

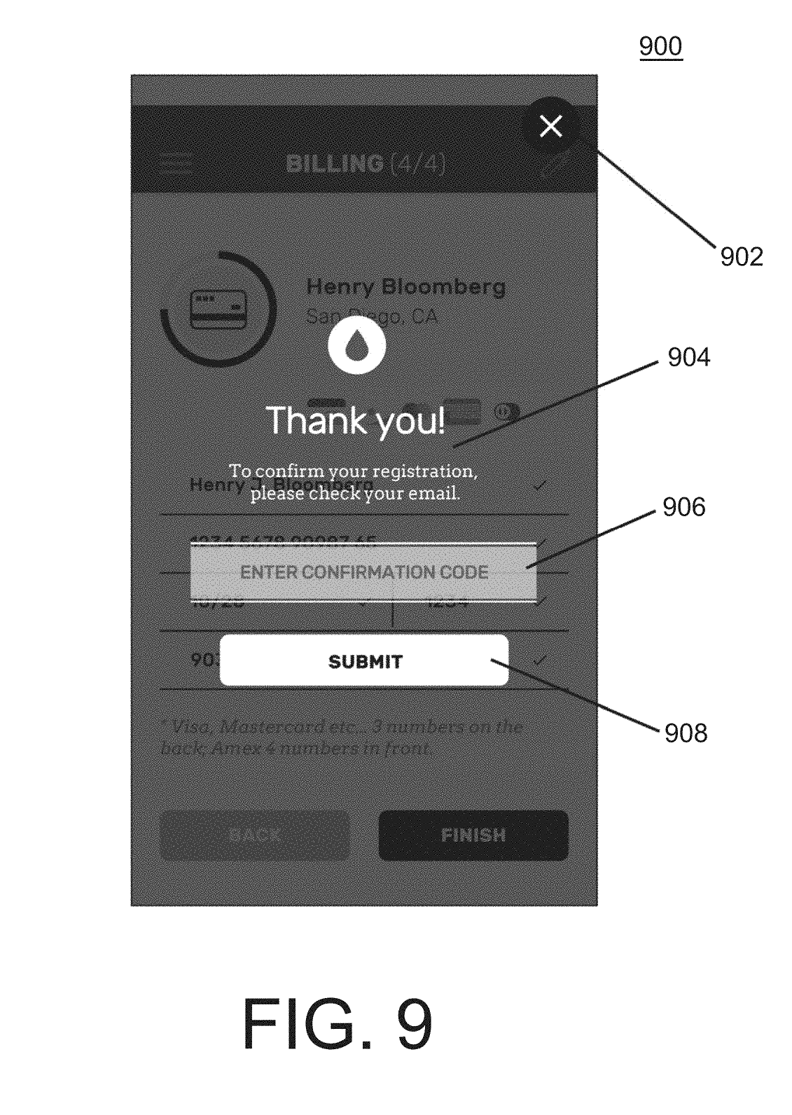

FIG. 9 shows a thank you screen 900 according to at least one aspect of the present disclosure. Thank you screen 900 has a close icon 902 that closes out of the screen, thank you message 904, confirmation code 906 to enter a confirmation code that was sent to the requester's email address and a submit button 908 to press which confirms the confirmation code and hence, the requester's registration with the app. After clicking the submit button 908, the user is officially registered within the app as a requester and can start using the system to request service tasks.

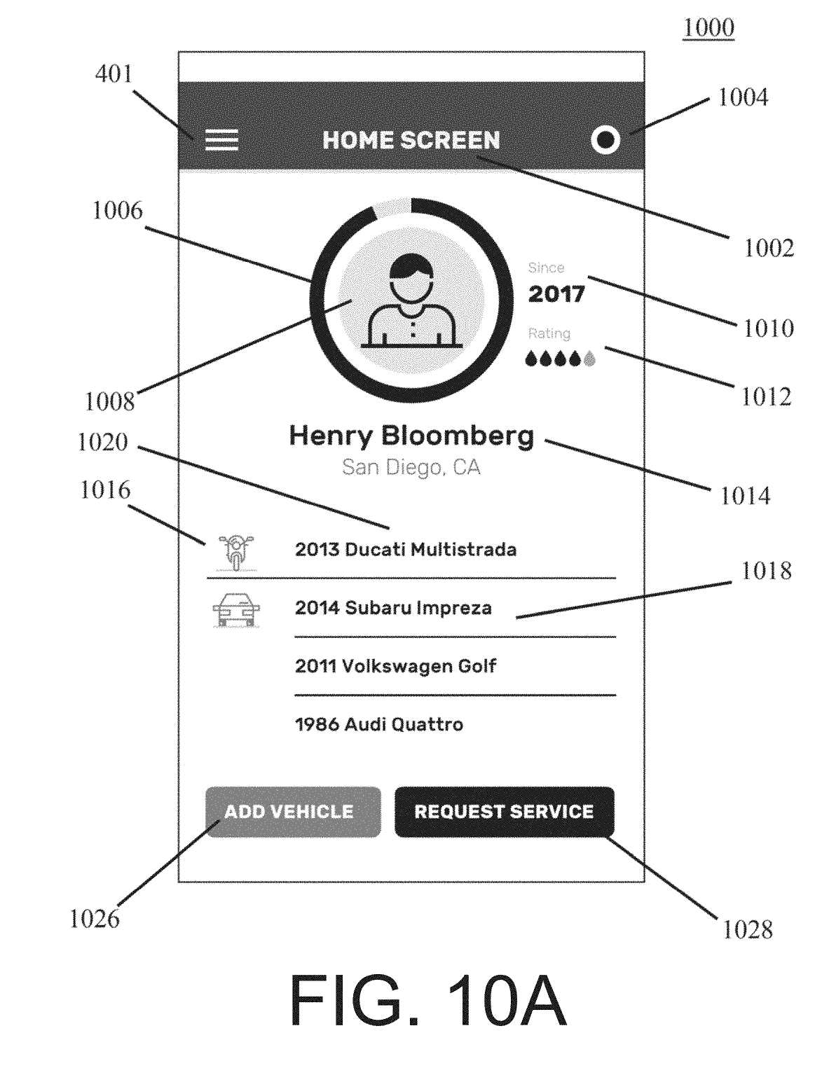

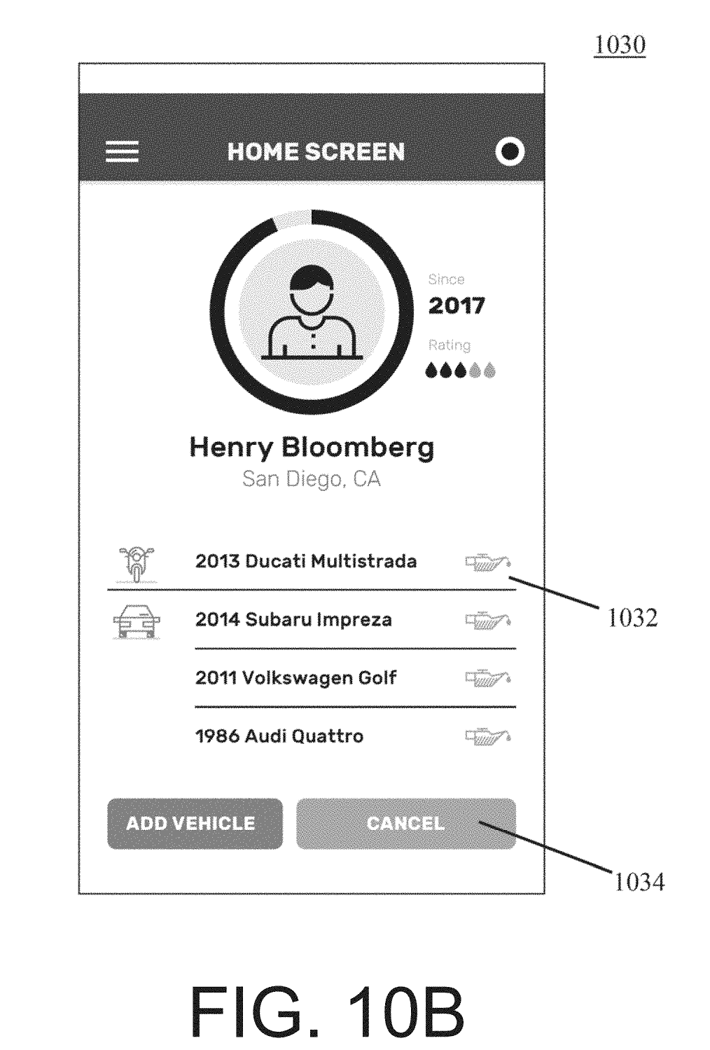

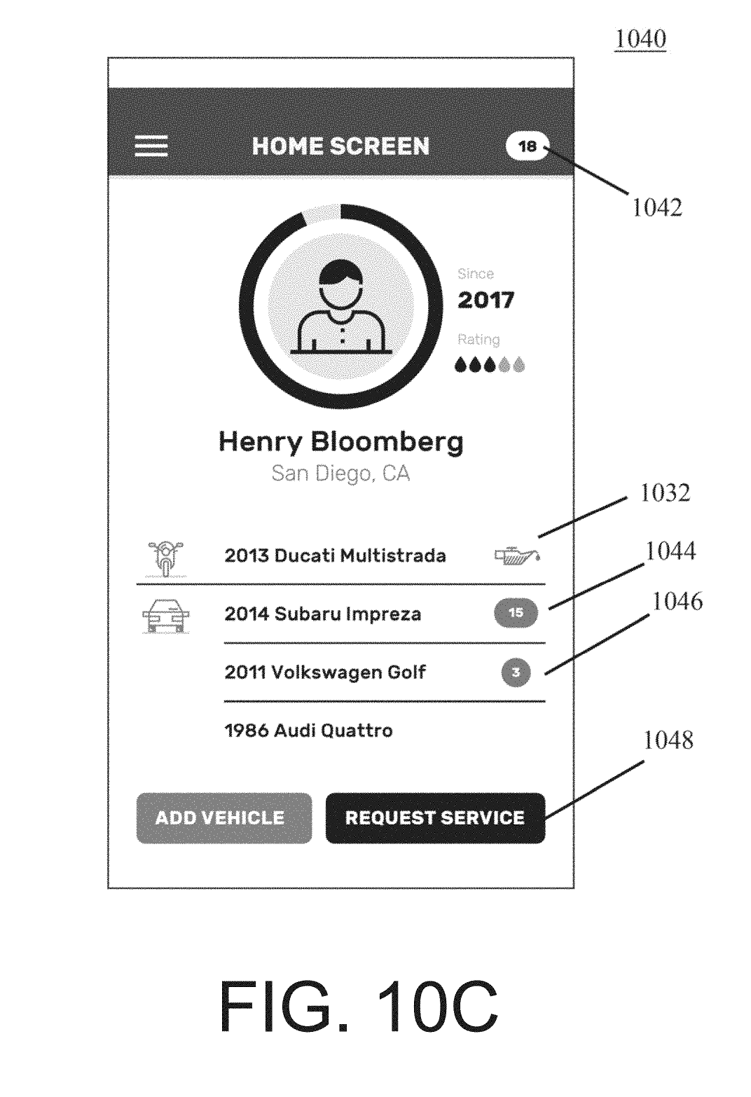

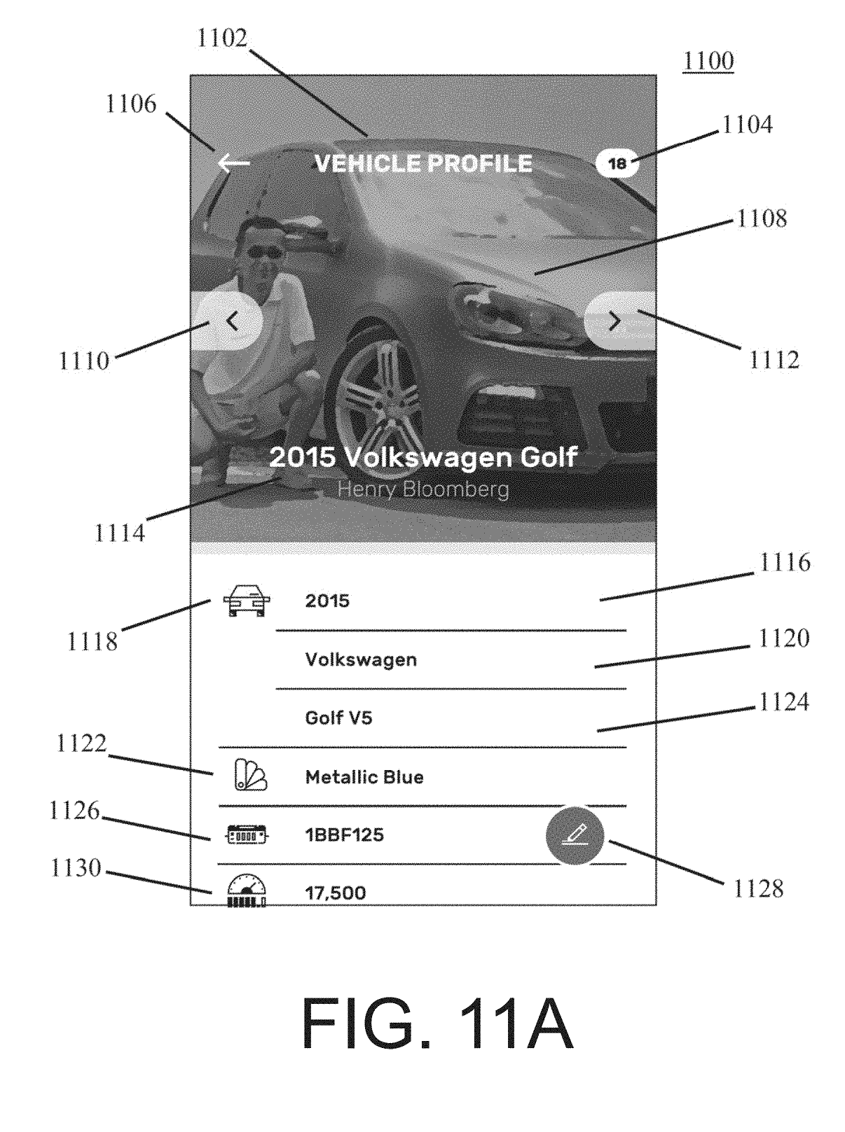

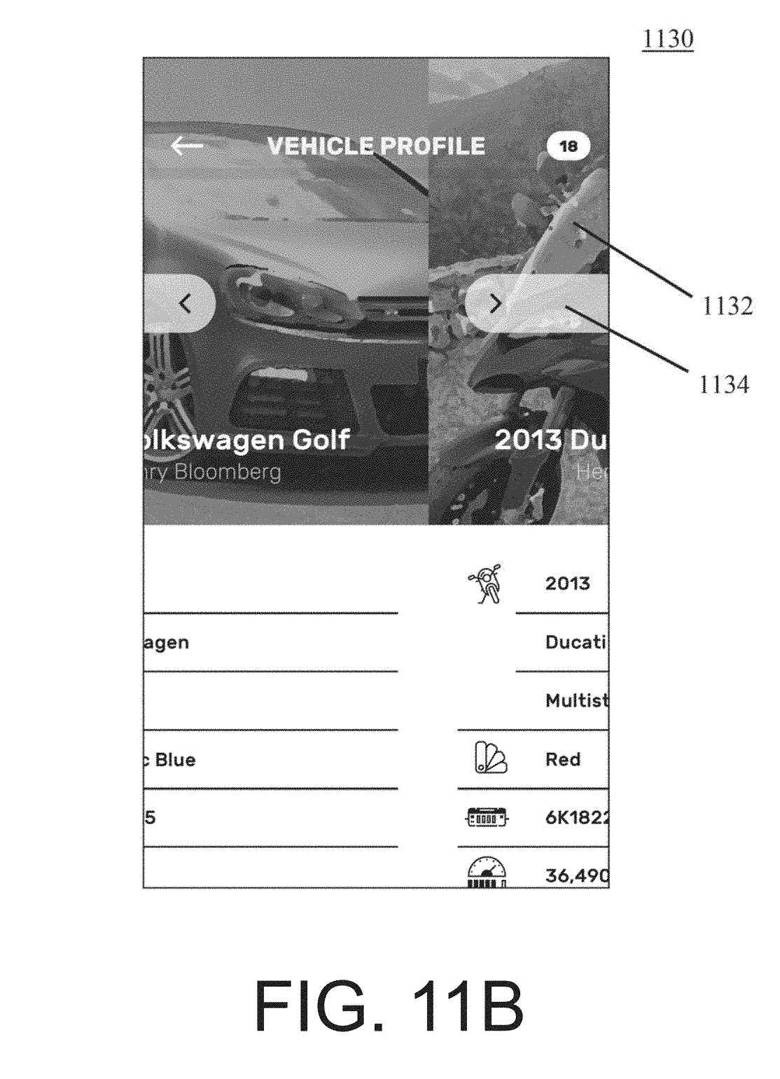

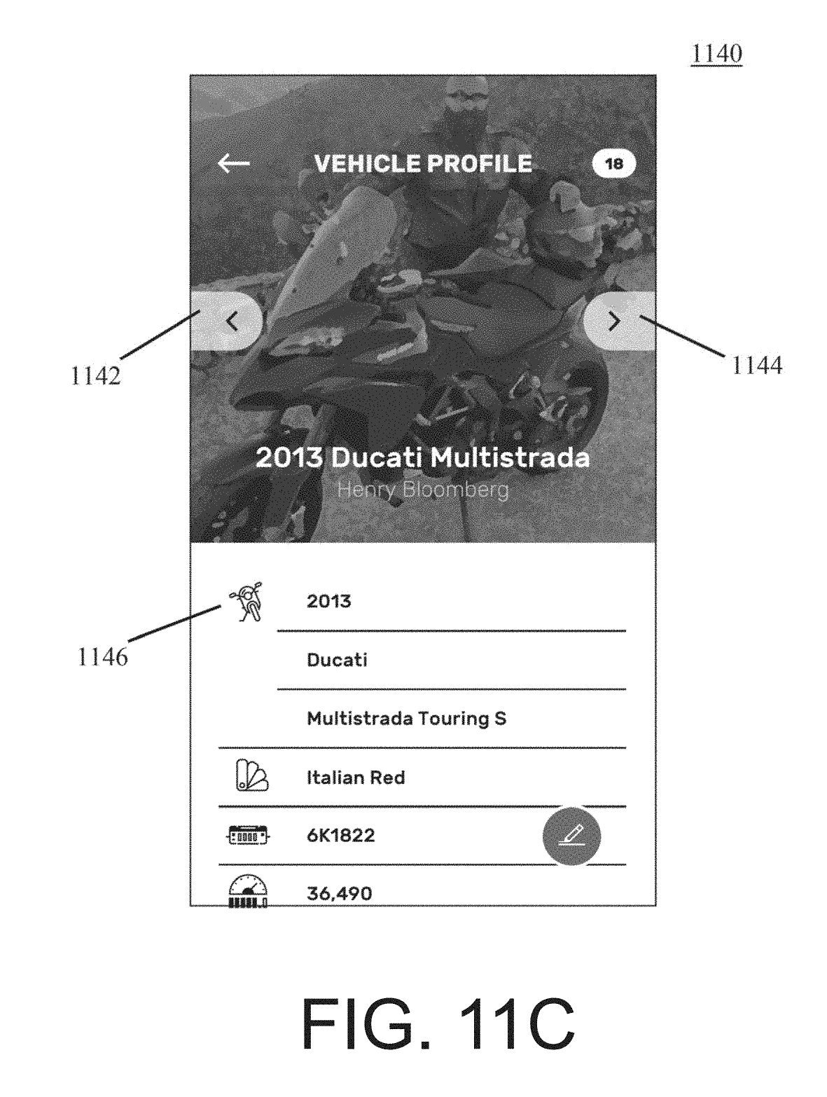

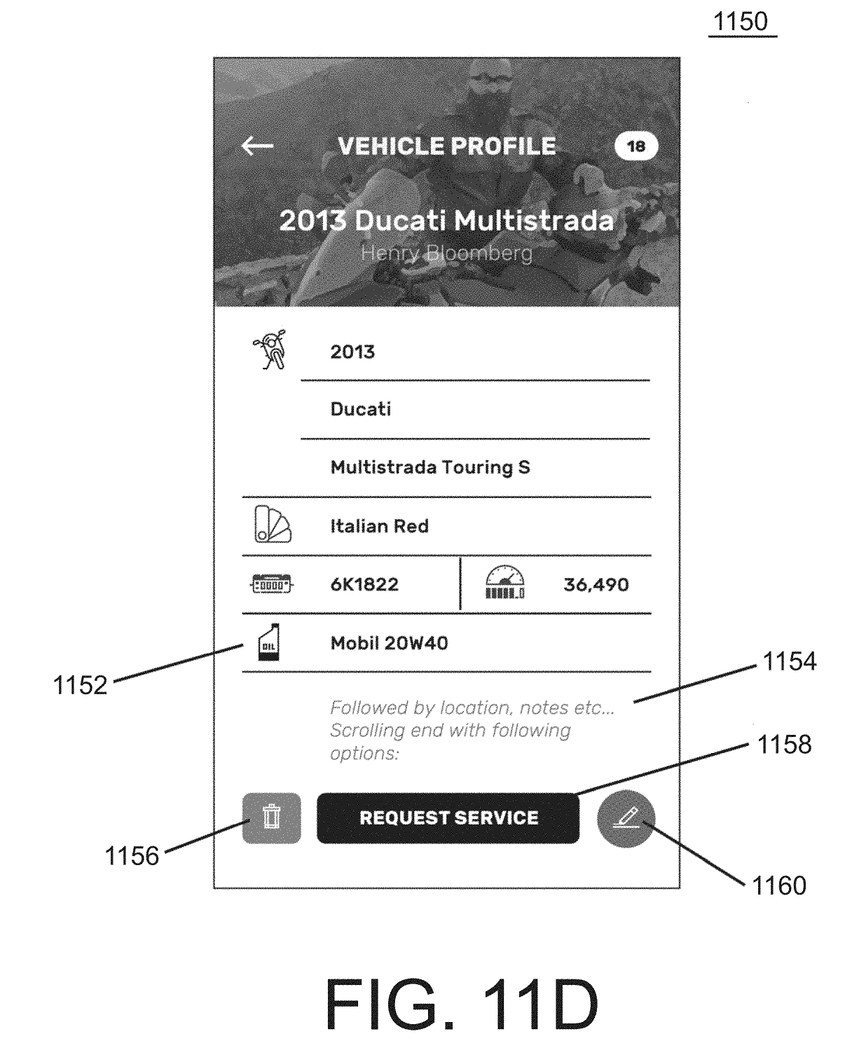

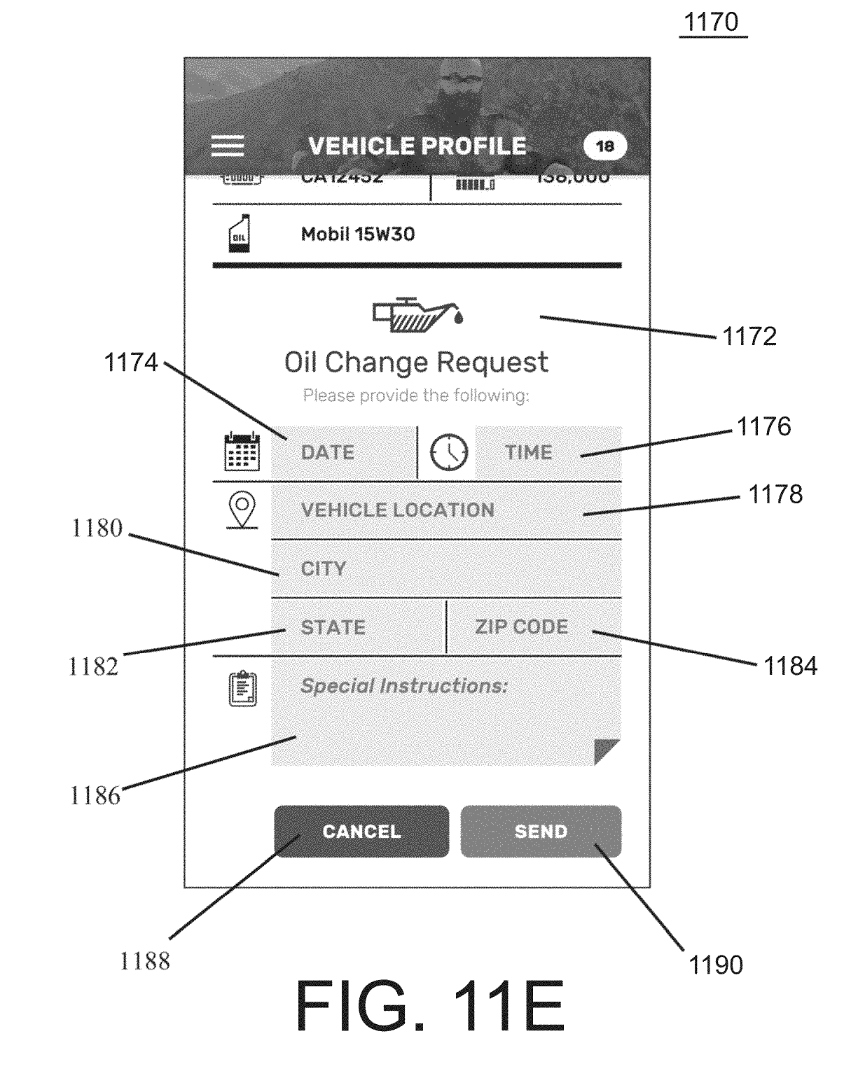

FIGS. 10A-10C show various home screens according to at least one aspect of the present disclosure. Home screen 1000 shows home screen text 1002, menu icon 401 (which brings the requester to FIG. 20), edit information icon 1004 (which allows the requester to edit information when clicked or simply displays an orb when no services are being counted), progress bar 1006, profile picture 1008, member since year 1010 (which describes what year the requester joined and became registered with the app) and rating 1012 (which is the rating ascribed to the requester that servicers and other requesters can see). Requester name and city 1014 is also shown, as is a list of vehicles underneath, each vehicle entry 1020 having a vehicle type icon 1016, a year-make-model descriptor 1018. If the requester clicks the add vehicle button 1026 they can add another vehicle. If the requester clicks the request service button 1028 they can request a service task for one of their vehicles, and then are taken to screen 1030 of FIG. 10B. FIG. 10B is nearly identical to screen 1000 of FIG. 10A, with the exception of service icons 1032 (here shown as oil spittoons) showing up next to each of the vehicle entries 1020. Also, previously the request service button 1028, the cancel button 1034 now shows up, which cancels the request of a service for any of the vehicles listed by vehicle entries. If the requester clicks on one of the service icons 1032 next to the vehicle entry 1020, they are then taken to screen 1040 of FIG. 10C. FIG. 10C shows screen 1040, which shows service counter 1042—that displays the number of service tasks a requester has done—as well as undone service task 1032 and first counter 1044—showing the number of service tasks that particular vehicle has done—and second counter 1046—showing the number of service tasks the other particular vehicle has done. When the requester clicks the request service 1048, then they can request the selected service task for the vehicle shown by the vehicle entry 1020. If the requester clicks on any of the vehicle entries 1020 or on the text of the vehicle entries 1020 (e.g., the year, make or model) they may be brought to FIGS. 11A-11E.

FIGS. 11A-11E show various vehicle profile screens according to at least one aspect of the present disclosure. Screen 1100 shows a vehicle profile, which includes vehicle profile text 1102, back button 1106 (that takes the requester back to the previous screen, e.g. FIGS. 10A-10C), service counter 1104 that shows the amount of service tasks have been performed on this vehicle, background picture 1108 showing a picture of the vehicle with perhaps the driver, previous vehicle button 1110 that shifts the screen to the previous vehicle entry 1020 in the list and next vehicle button 1112 that shifts the screen to the next vehicle entry 1020 in the list. Information about the vehicle is shown in vehicle type icon 1118, vehicle year 1116, vehicle make 1120, vehicle model 1124, vehicle color 1122, license plate number 1126, mileage 1130. Edit information icon 1128 allows the requester to edit or modify any of the shown fields for the vehicle of the displayed vehicle profile. FIG. 11B and screen 1130 is the transition screen when the requester clicks the next vehicle button 1112, with the next vehicle (the next vehicle entry 1020) being shown in the next vehicle transition image 1132, and with the next vehicle button 1112 being expanded into the transition button 1134. FIG. 11C and screen 1140 shows another vehicle, with the same information from FIG. 11A and screen 1100 repeated, with the exception of the vehicle type icon 1146 being a two-wheeler or motorcycle instead of a car, like 1118 in FIG. 11A and screen 1100. FIG. 11D and screen 1150 is FIG. 11C and screen 1140 scrolled down some more, with the preferred oil type 1152 for the vehicle now visible. Notes 1154 also appear, showing any special notes the requester wanted to leave regarding the vehicle. Delete icon 1156 deletes this vehicle (and vehicle entry 1020) from the list of the requester's vehicles, edit information icon 1160 is the same as edit information icon 1128 from before (just in a different form at the bottom of the page instead of floating along the page like 1128), and request service icon 1158, when clicked, requests a service task for the currently shown vehicle in the visible vehicle profile of screen 1150 (here, the 2013 Ducati Multistrada). When request service icon 1158 is clicked, then screen 1170 of FIG. 11E appears, showing the service task request type 1172 (here, an oil change request), request date 1174, request time 1176, vehicle location 1178, city 1180, state 1182, zip code 1184, special instructions 1186 and cancel 1188, when clicked, cancels the request while send 1190, sends the request out via the app to a servicer who can perform the service task on the vehicle.

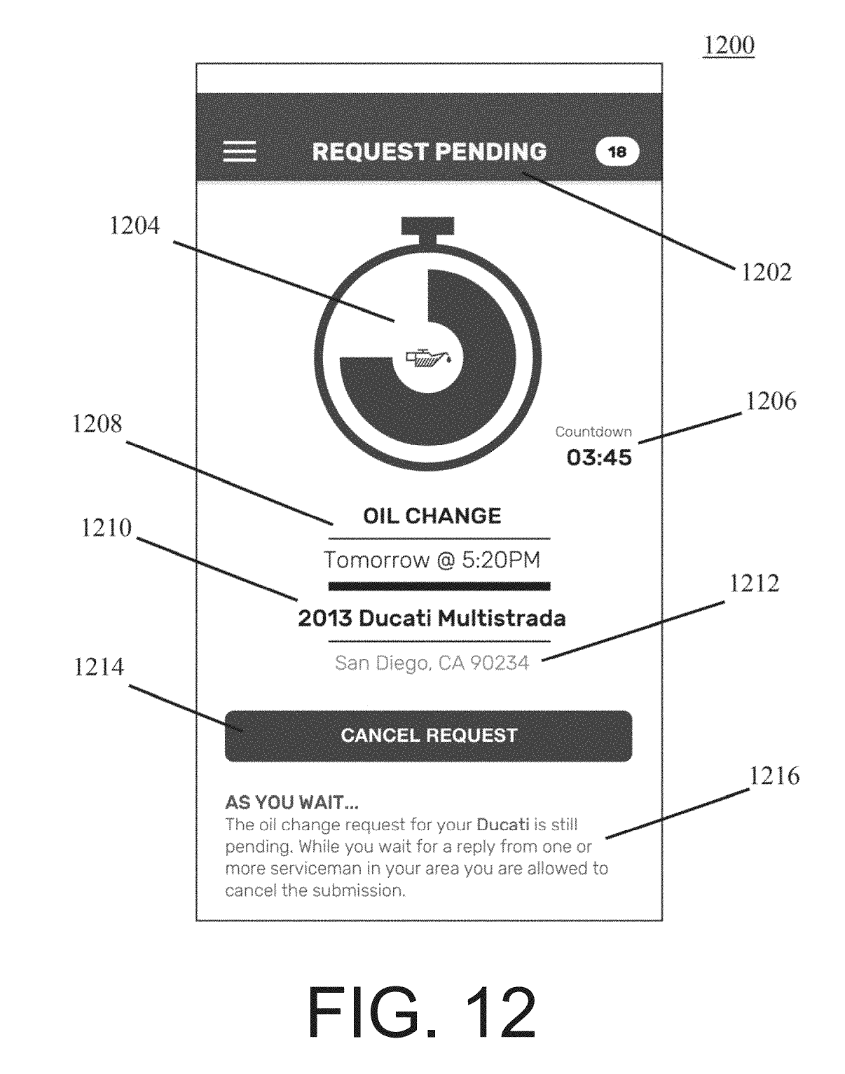

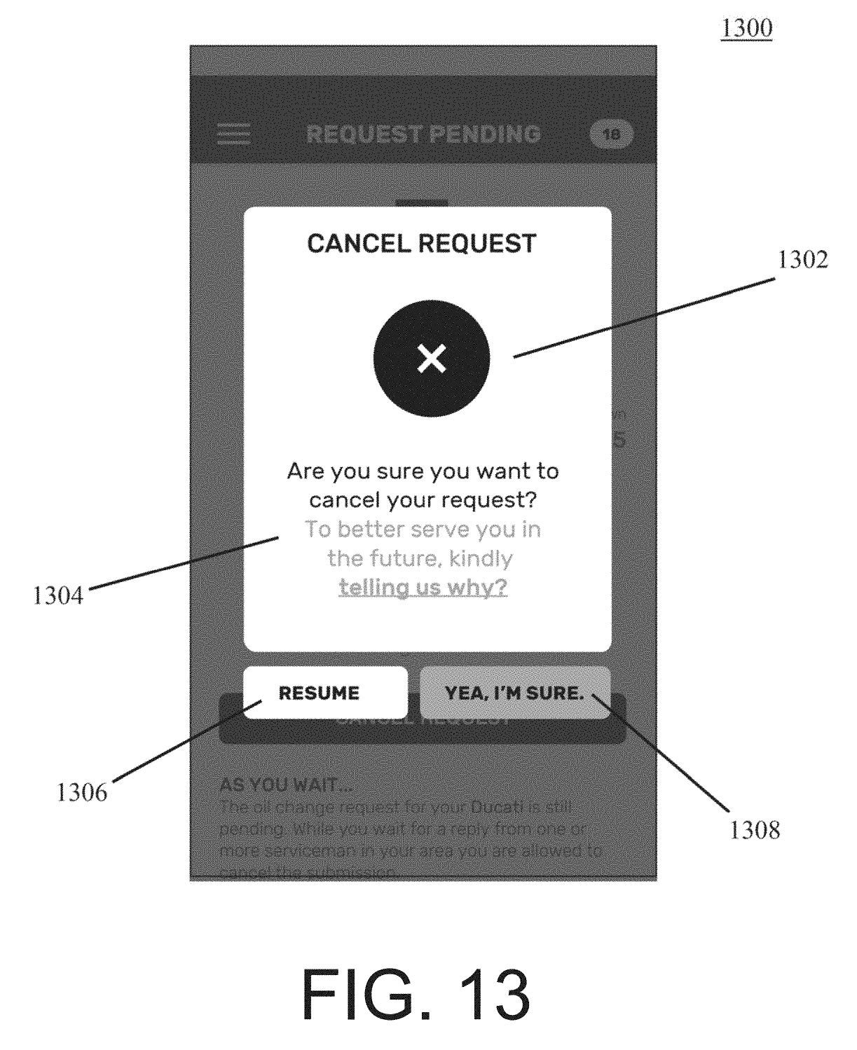

FIG. 12 shows a request pending screen 1200 according to at least one aspect of the present disclosure. Screen 1200 shows request pending text 1202, wait bar 1204 (to show how much time has progressed until the limit, which can be pre-set or can be predetermined), countdown timer 1206 (which shows the elapsed time since the request or counts down from a predetermined time that is the minimum time necessary to wait for a request to be honored), service task type and time 1208, vehicle information 1210, vehicle location 1212, and cancel request button 1214, which if clicked, cancels the current service task request. Notes 1216 indicates to the requester that the oil change request is still pending and that while the requester waits for a reply from the servicers they are allowed to cancel the submission If the requester clicks the cancel request button 1214, they are also taken to screen 1300 of FIG. 13.

FIG. 13 shows a cancel request screen 1300 according to at least one aspect of the present disclosure. Screen 1300 shows cancel request icon 1302—identifying the cancellation of the service task request—and cancellation text 1304, which asks the requester if they are sure they want to cancel the service task request, which can be confirmed by the requester (“Yea, I'm sure” I wish to cancel the request) by clicking the confirm cancel button 1308, or not confirmed by clicking the resume button 1306, which resumes the requested service task.

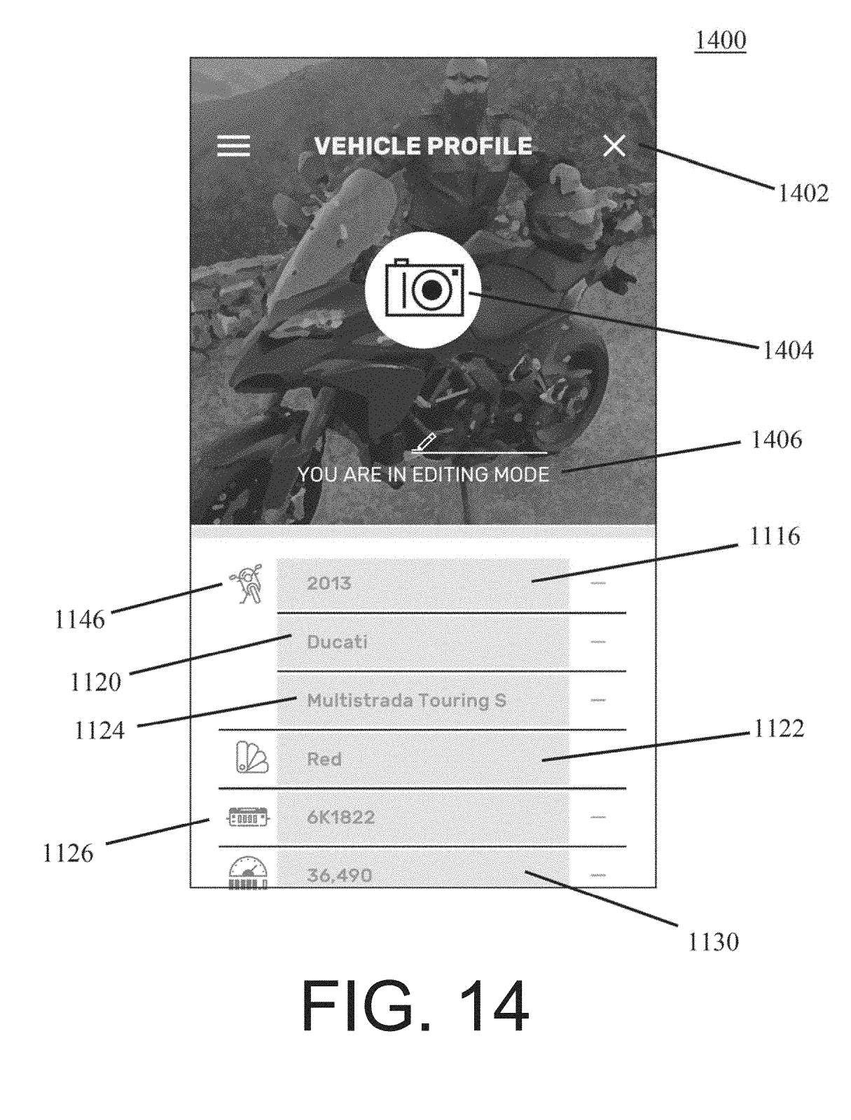

FIG. 14 shows an editing mode 1400 of a vehicle profile screen according to at least one aspect of the present disclosure. Screen 1400 has a close screen icon 1402 that closes out of this screen, upload photo icon 1404 that allows the requester to upload a background photo for a vehicle, editing mode text 1406 to inform the requester that they are in editing mode, and the same vehicle data from the vehicle profile shown previously in FIG. 11A (screen 1100) and FIG. 11C (screen 1140) 1146 (or 1118) vehicle type, make 1120, model 1124, color 1122, license plate number 1126 and mileage 1130.

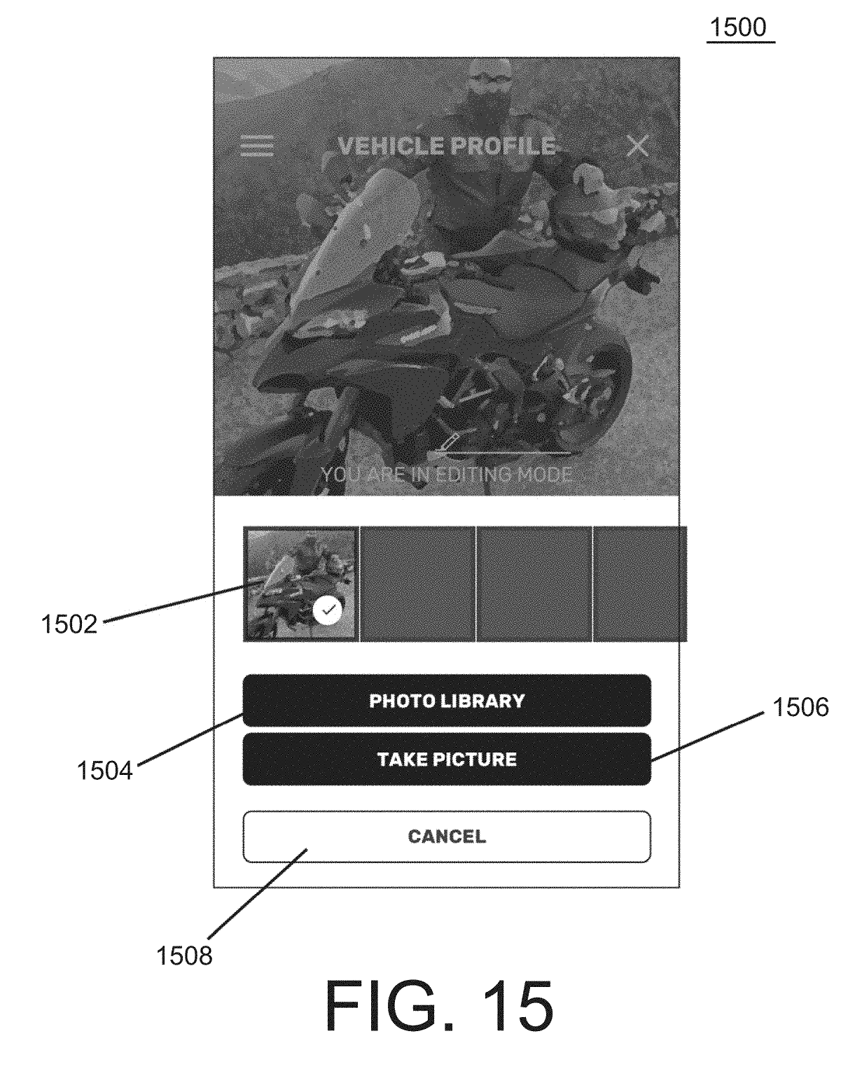

FIG. 15 shows a photo select screen 1500 of an editing mode of a vehicle profile screen according to at least one aspect of the present disclosure. Screen 1500 shows selected photo 1502 (which can be pulled via a browser off a smart phone device's cache of photos or a local computer storage drive) having a check mark showing that is the photo to be uploaded as the background photo to replace vehicle background photo 1108 (see FIG. 11A). Photo library icon 1504, when clicked, takes the requester to the photo library, and take picture icon 1506 converts the smart phone/tablet/computer device into camera mode (if present) to take a picture to be instantly uploaded as the background photo 1108. The cancel button 1508, when clicked, cancels the photo select screen 1500 and returns the requester to FIG. 14.

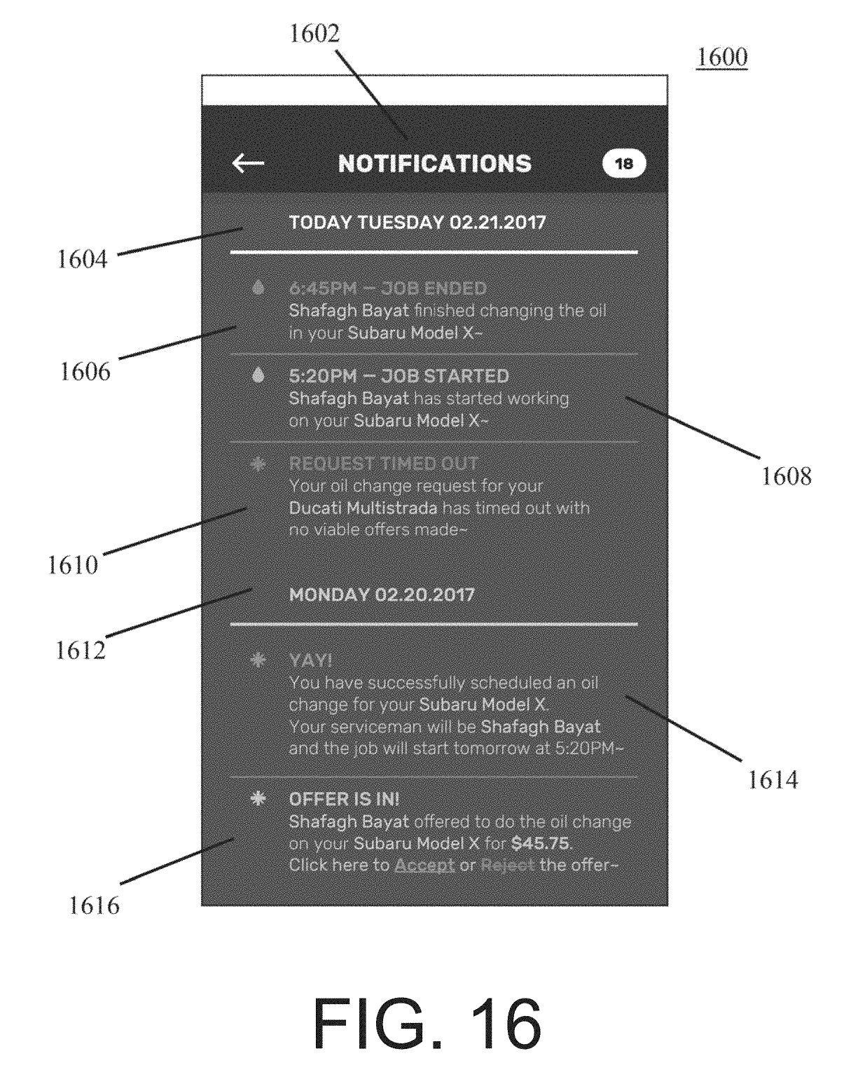

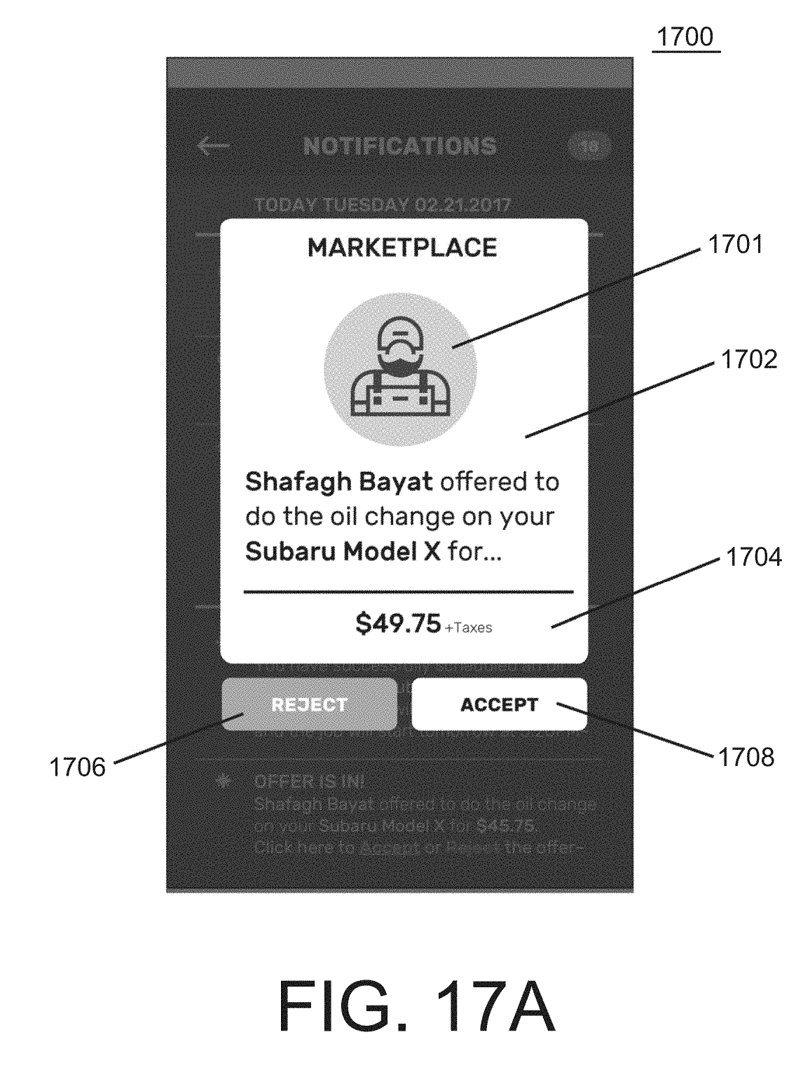

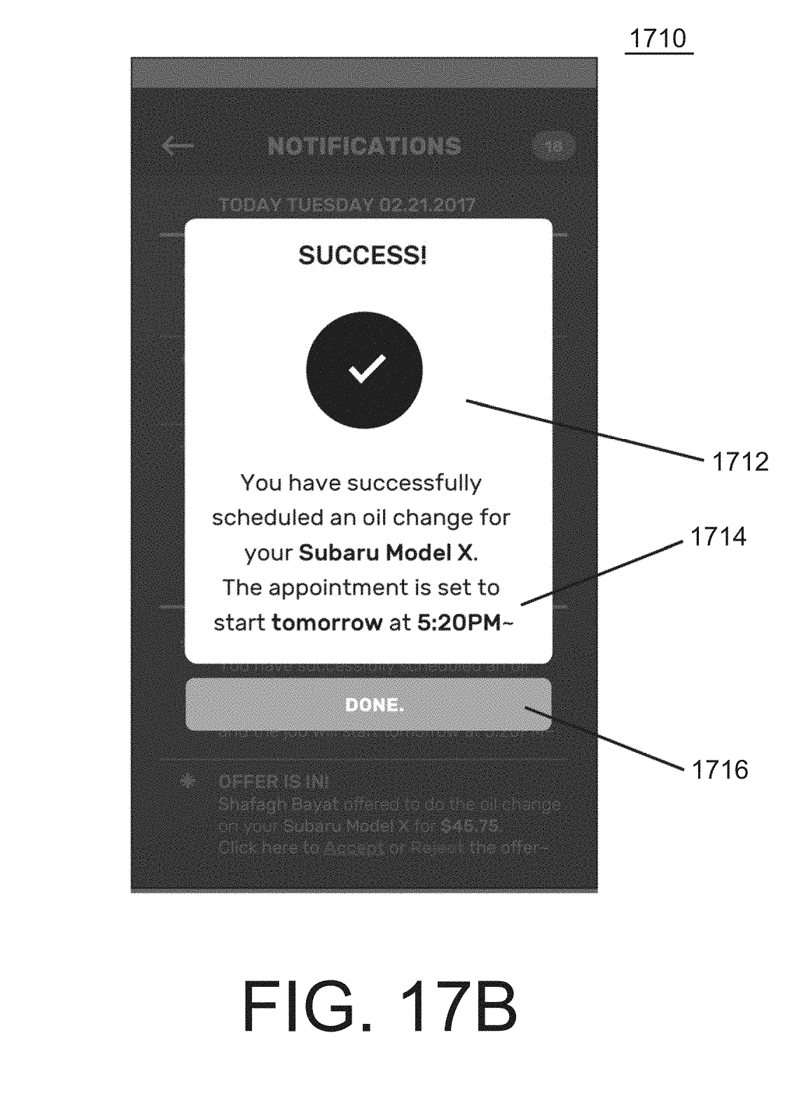

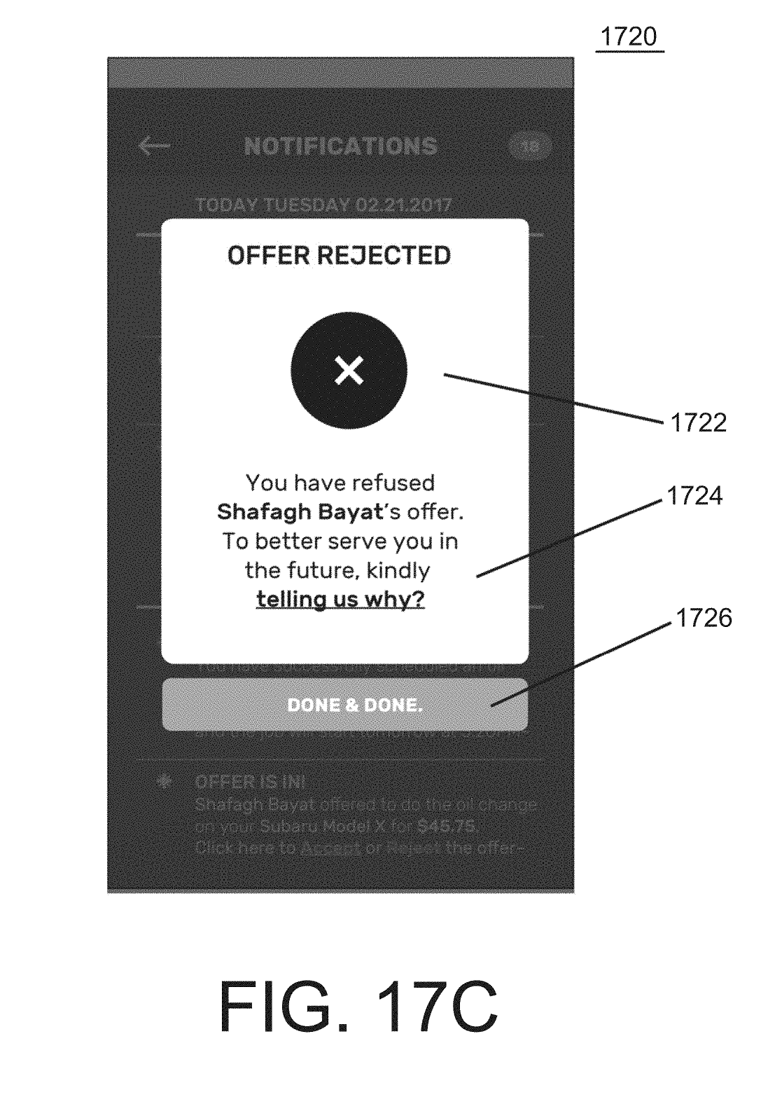

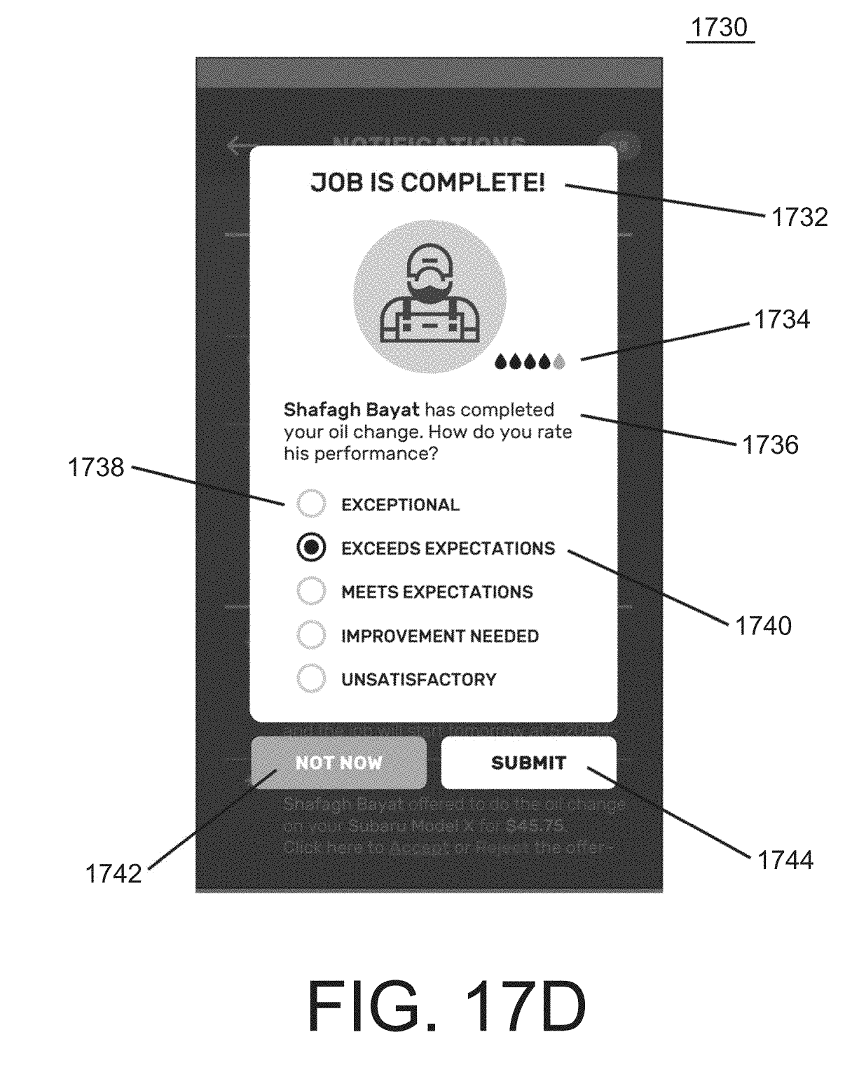

FIG. 16 shows a notification screen 1600 according to at least one aspect of the present disclosure. Screen 1600 has notifications text 1602, day-date indicator 1604 and 1612 (reflecting a day of the week and date in MM/DD/YYYY format, for example) and a number of different notifications: first notification 1606 reflects the ending of a job or a service task, second notification 1608 reflects the starting of a job or service task, third notification 1610 reflects the timing out of a job or service task, fourth notification 1614 reflecting the successful scheduling of a service task on a requester's vehicle and fifth notification 1615, reflecting that a servicer has offered to do an oil change on a vehicle owned by the requester, with the requester able to accept or reject the offer by clicking on the text of the notification 1615. If the requester clicks the fifth notification 1615 or the accept or reject text in the fifth notification 1615, they are then taken to FIG. 17A and screen 1700.

FIGS. 17A-17D show various marketplace screens according to at least one aspect of the present disclosure. Screen 1700 shows a servicer profile picture 1702, servicer text 1702 describing the servicer name and that they offered to do a service task for the requester at the listed price 1704, with reject button 1706—if clicked rejecting the offer by the servicer and accept button 1708—if clicked, accepting the offer by the servicer. If the accept button 1708 is clicked, then the requester is brought to FIG. 17B and screen 1710, which shows a success icon 1712, and confirmation text 1714 describing that a service task has been scheduled with the servicer for which of the requester's vehicles, as well as the date and time of the service task appointment. Clicking on the done button 1716 will bring the requester back to the notifications screen 1600 of FIG. 16. However, if the requester clicks the reject button 1706, they are brought to screen 1720 of FIG. 17C, which shows an offer rejected icon 1722, and offer rejected text 1724 confirming to the requester that they have rejected the servicer's offer. There is also a link in the rejected text 1724 where the requester can provide reasons as to why he or she rejected the servicer's offer, which may lead to better Quality Assurance (QA) or improvements of the app. The done button 1726 returns the requester to the notifications screen 1600 of FIG. 16. When the servicer has completed the service task, the job is complete screen 1730 of FIG. 17D appears, which shows the job is complete text 1732, the servicer's rating 1734 (which may be configurable so that the requester can provide a rating of the servicer by clicking on a location of the list, e.g. to indicate how many oil drops—or stars, icons, thumbs up—to give the servicer) and job complete description 1736 which prompts the requester to rate the servicer's performance by clicking a selected performance level 1740 out of several choice performance levels 1738. In one aspect, the scale represented by the choice performance levels 1738 may correlate directly to the ranking or rating shown by the servicer's rating 1734, which may be a graphical representation of an average of how many of a given type of choice performance levels were received; e.g. equating a number to each performance level from 1 to 5, and the number of oil drops appearing also representing an average between 0 to 5 of average performance level ratings. The not now button 1742, when clicked, does not send the performance rating of selected performance level 1740 to the server of the app and to the servicer's collective rating average total. The submit button 1744, when clicked, sends the performance rating of the selected performance level 1740 to the relevant server of the app and then subsequently affects the servicer's collective rating average total.

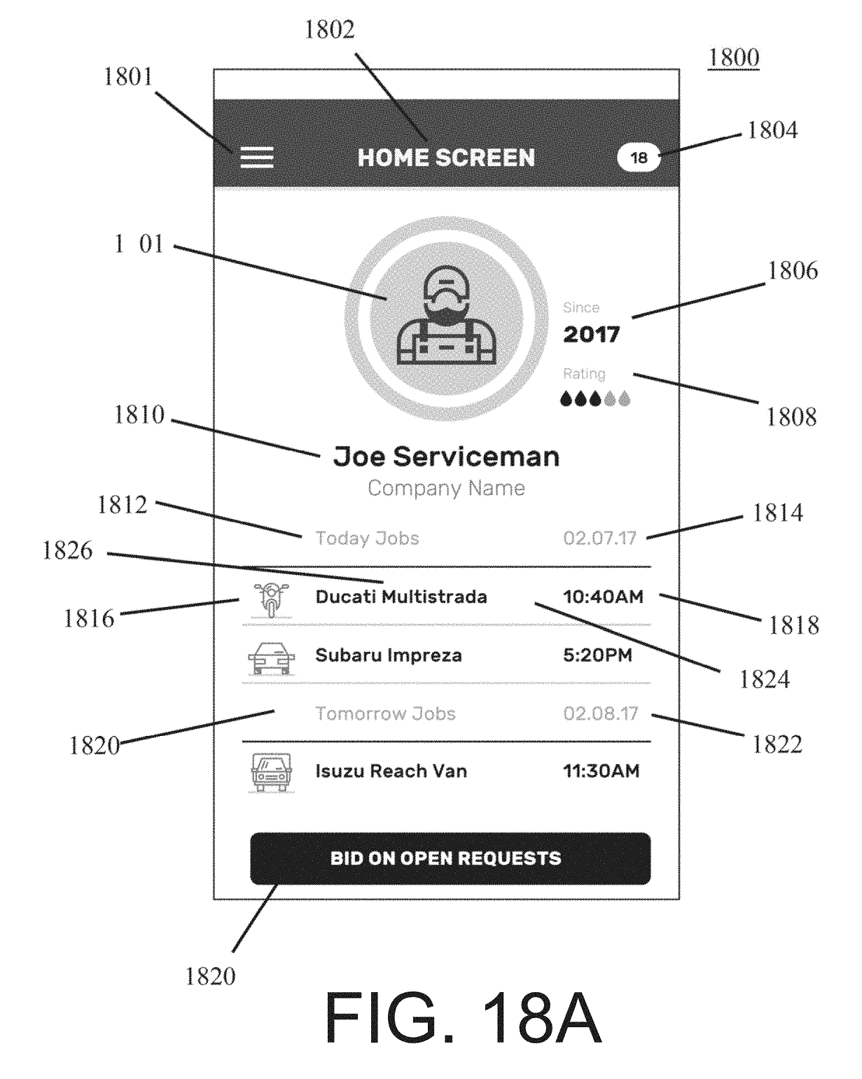

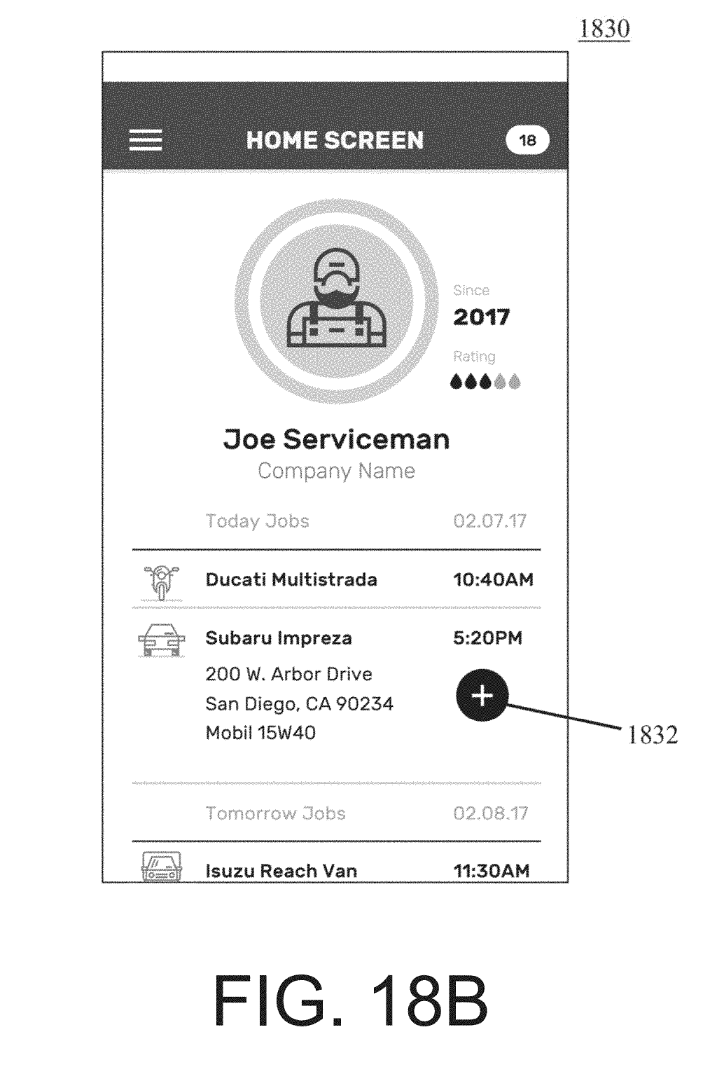

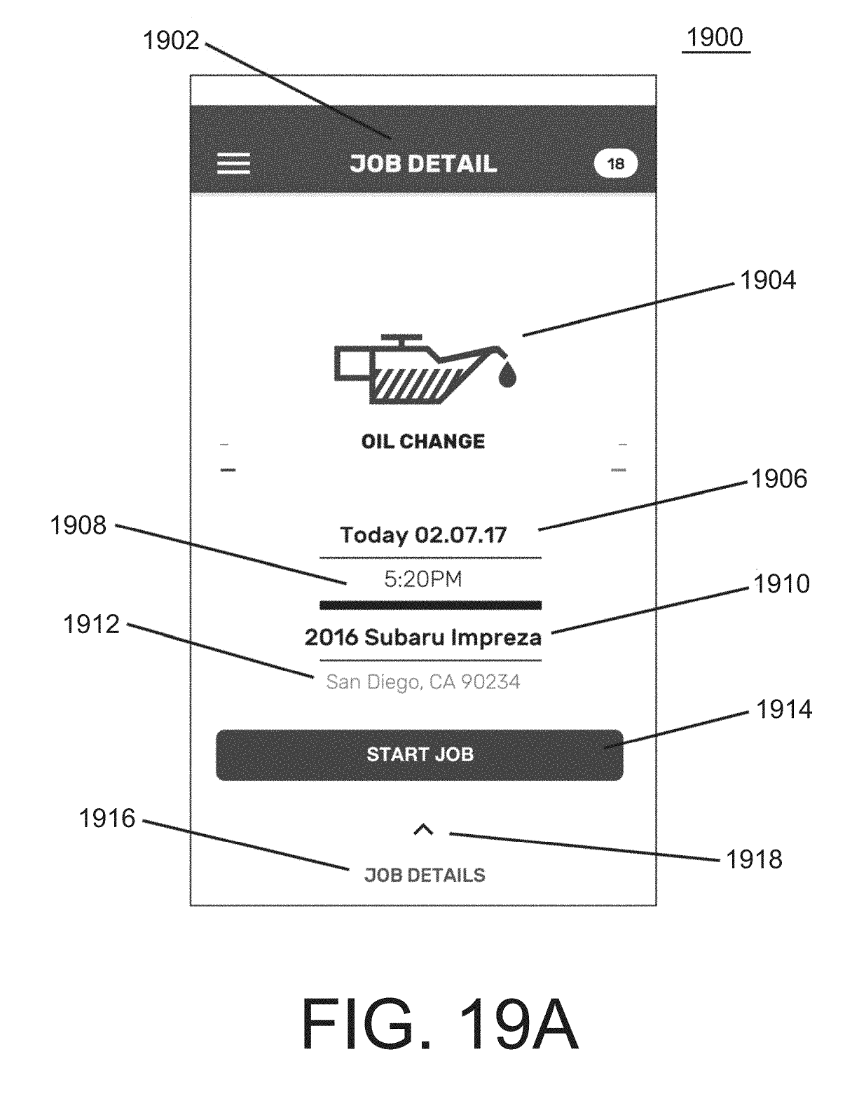

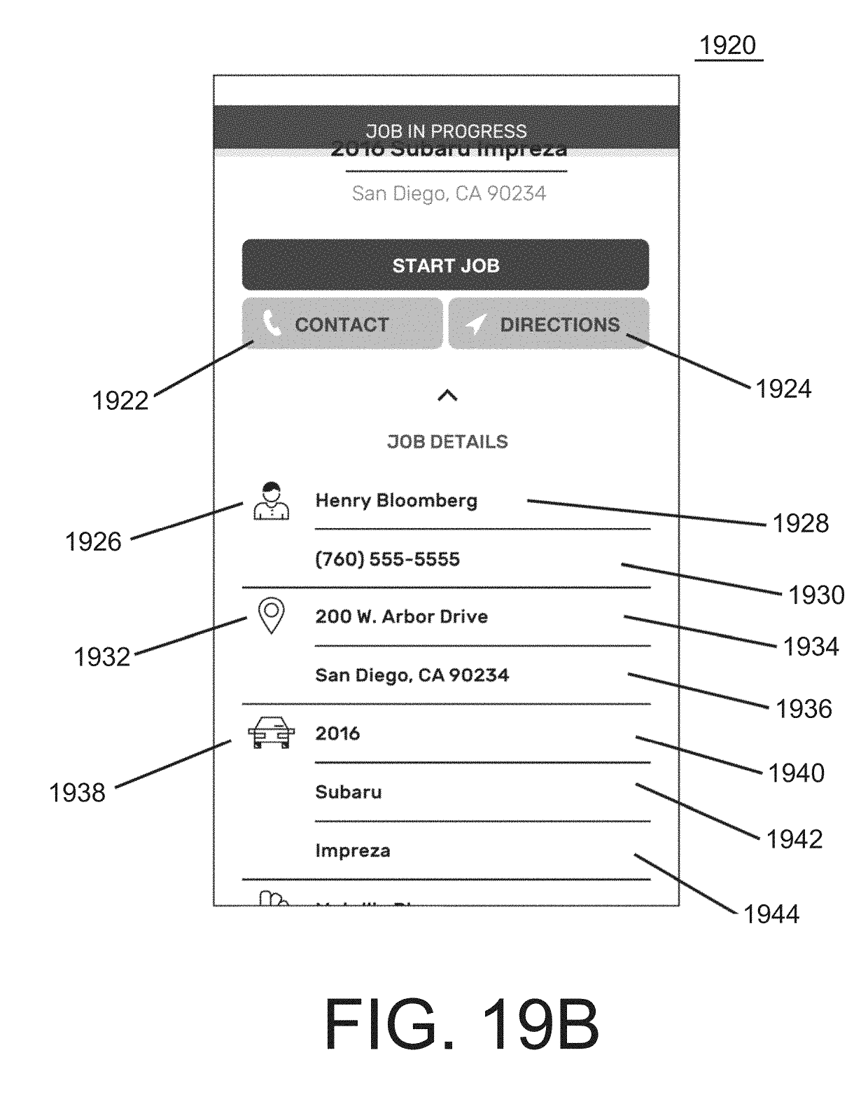

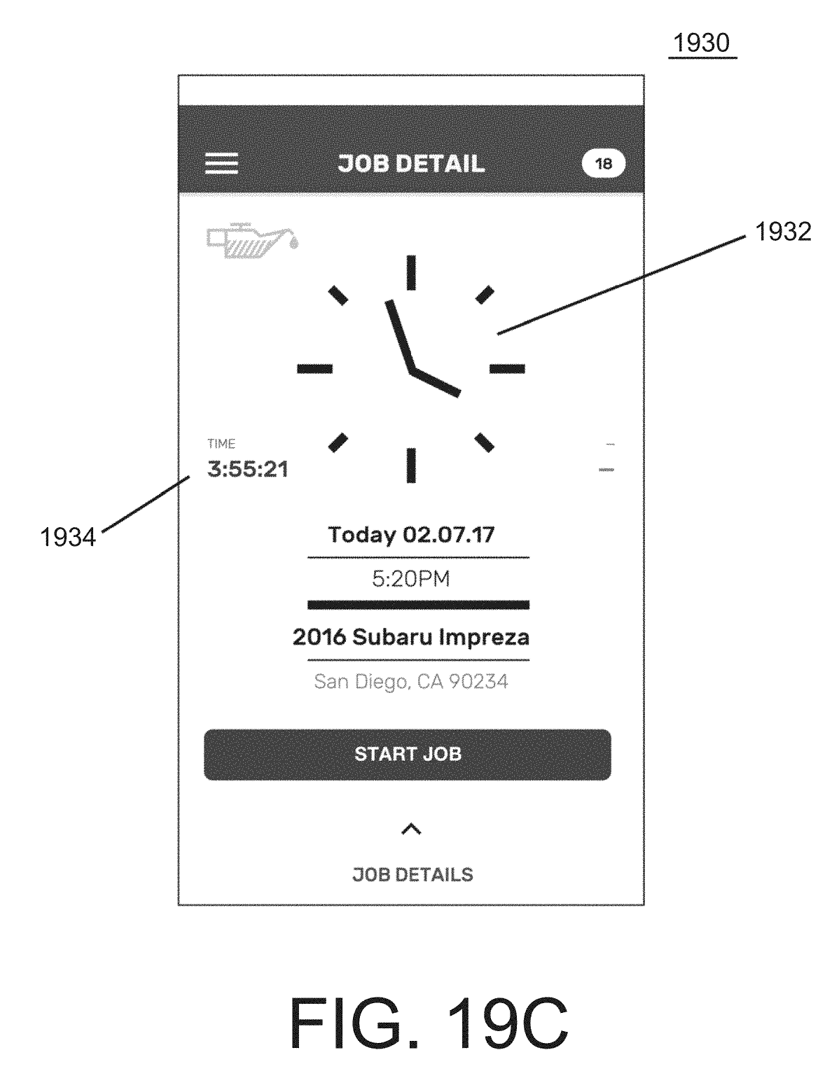

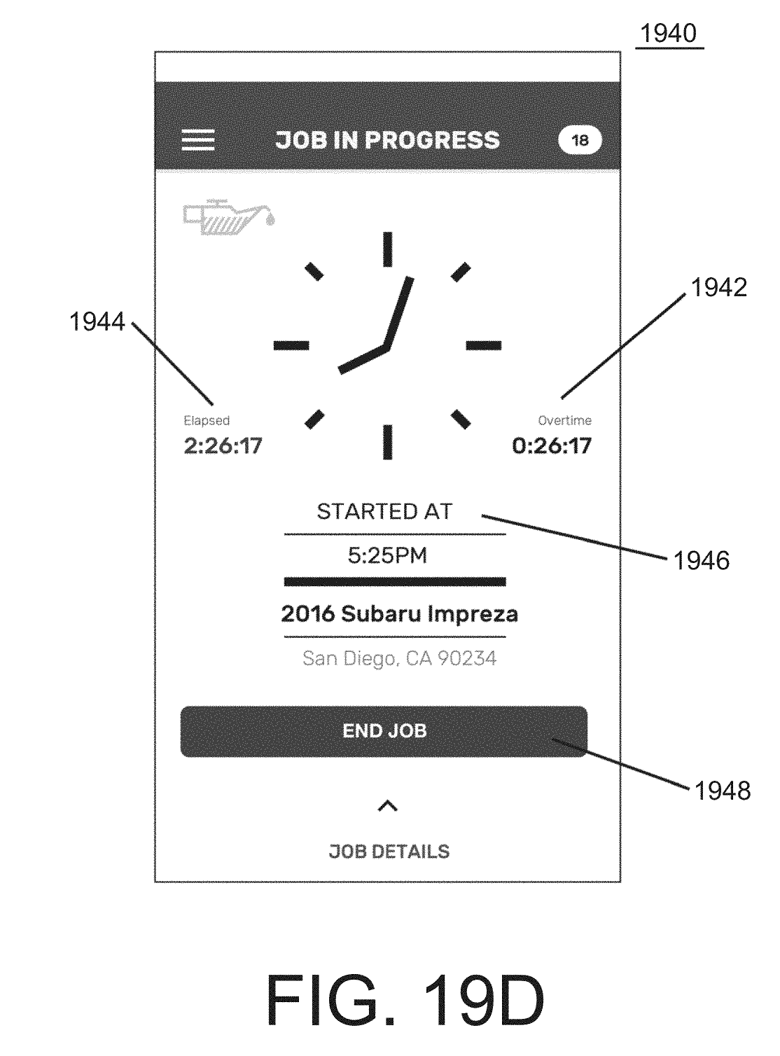

FIGS. 18A-18B show various servicer screens according to at least one aspect of the present disclosure. Screen 1800 is a home screen of a servicer, or the home screen that greets the servicer when they log into the app, showing home screen text 1802, menu icon 1801 (which when clicked brings the servicer to a similar screen as FIG. 20 for requesters), service counter 1804 (showing the number of service tasks that servicer has performed), profile picture 1701, member since year 1806, rating 1808, name and company name 1810, current day indicator 1812 and date indicator 1814 as well as future or previous day indicator 1820 and future or past date indicator 1822, where a number of jobs or service tasks are listed as service task entries 1824, each service task entry 1824 having a vehicle type icon 1816 showing the vehicle type, vehicle make and model indicator 1826 showing the vehicle make and model and service task time 1818, showing what time of day (of the day indicated by the indicators 1820 or 1812) the service task appointment is scheduled for. The bid on open requests button 1820, when clicked, allows the servicer to bid on currently open requests from requesters. Screen 1830 of FIG. 18B appears when the servicer clicks on any of the service task entries, which expands the service task entry 1824 to show the servicer more information about the service task, such as the address of the service task location, preferred oil type, and other relevant data. In one aspect, the information displayed can be customized. Also, job detail button 1832 appears, which when clicked, takes the servicer to screen 1900 of FIG. 19A.

FIGS. 19A-19D show various job detail screens according to at least one aspect of the present disclosure. Screen 1900 of FIG. 19A appears when the servicer clicks on job detail button 1832 of FIG. 18B. Screen 1900 shows job detail text 1902, service task type icon 1904 (here an oil change), date text 1906, time text 1908, make and model text 1910, state and city text 1912 (which all describe the location and time of the service task appointment) and the start job 1914 button, which is clicked when the servicer arrives at the relevant location and begins performing the service task. More icon 1918 reveals more of screen 1900, shown in screen 1920 of FIG. 19B, and expands the job details tab, which is currently shown by the retracted job details text 1916. Screen 1920 of FIG. 19B shows the job details of a job, which includes contact button 1922—allowing the servicer to contact the requester, either via phone, cell phone or text message—and directions button 1924, which pulls up a map program or GPS program to direct the servicer to the requester's location or the service task location to perform the service task. Details about the requester are also shown including requester name 1928, requester profile photo 1926, requester phone number 1930, requester location 1932, including requester address 1934 and requester city-state-zip-code 1936 (which can be the same as the service task location if say, the requester is stranded somewhere that is not there home address), requester vehicle type icon 1938 showing the type of vehicle of the requester, requester car year 1940, requester vehicle make 1942, and requester vehicle model 1944. FIG. 19C and screen 1930 appears when the 1904 icon is pressed, which shows clock 1932 instead of 1904 as well as elapsed time 1934. FIG. 19D and screen 1940 appears when the start job button 1914 is pressed, showing elapsed time 1944 and overtime clock 1942, as well as start time 1946. Once the servicer presses end job 1948, the service task ends.

FIG. 20 shows a requester menu according to at least one aspect of the present disclosure. Screen 2000 shows menu text 2002, requester profile photo, name and city 2006, notifications center 2008 (which takes the requester to FIG. 16 and screen 1600); in one embodiment, the job counter also is the number of notifications; the active requests icon 2010, the request history icon 2012, the account history icon 2014, the user preferences icon 2016, the sign out icon 2018 and the contact icon 2020, which takes the requester to the relevant sections of the app when clicked.

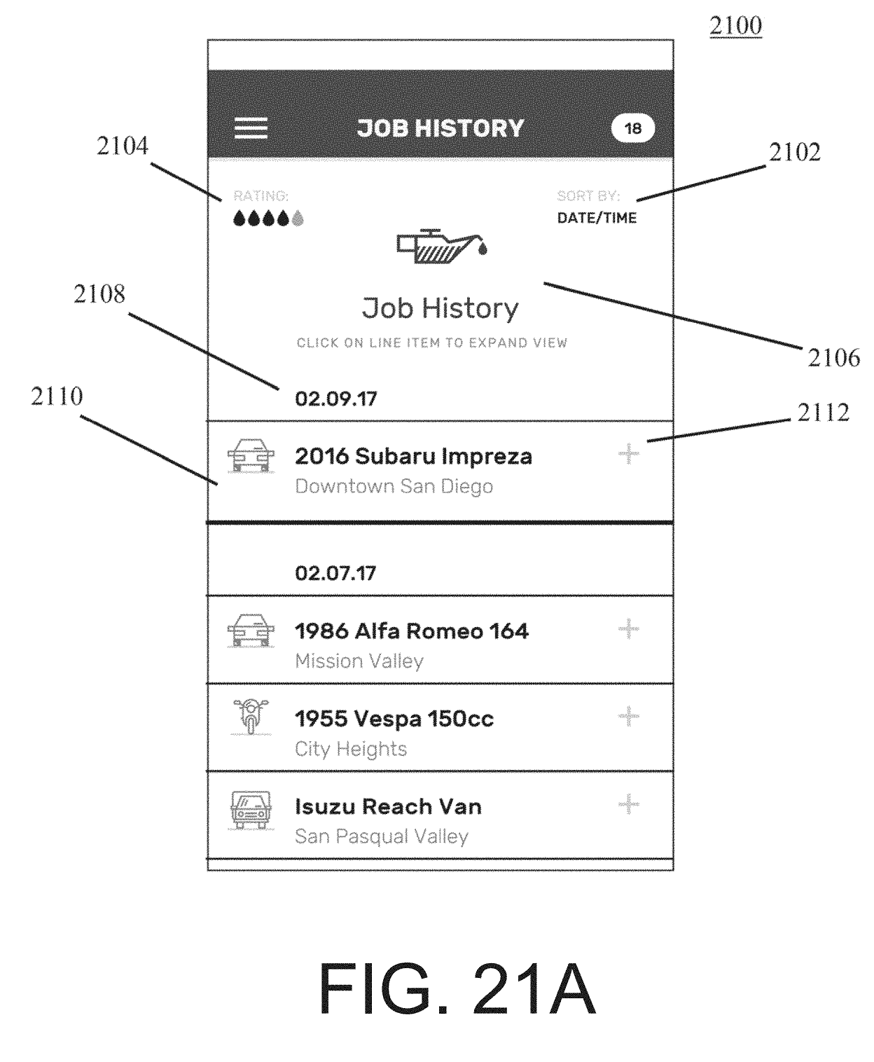

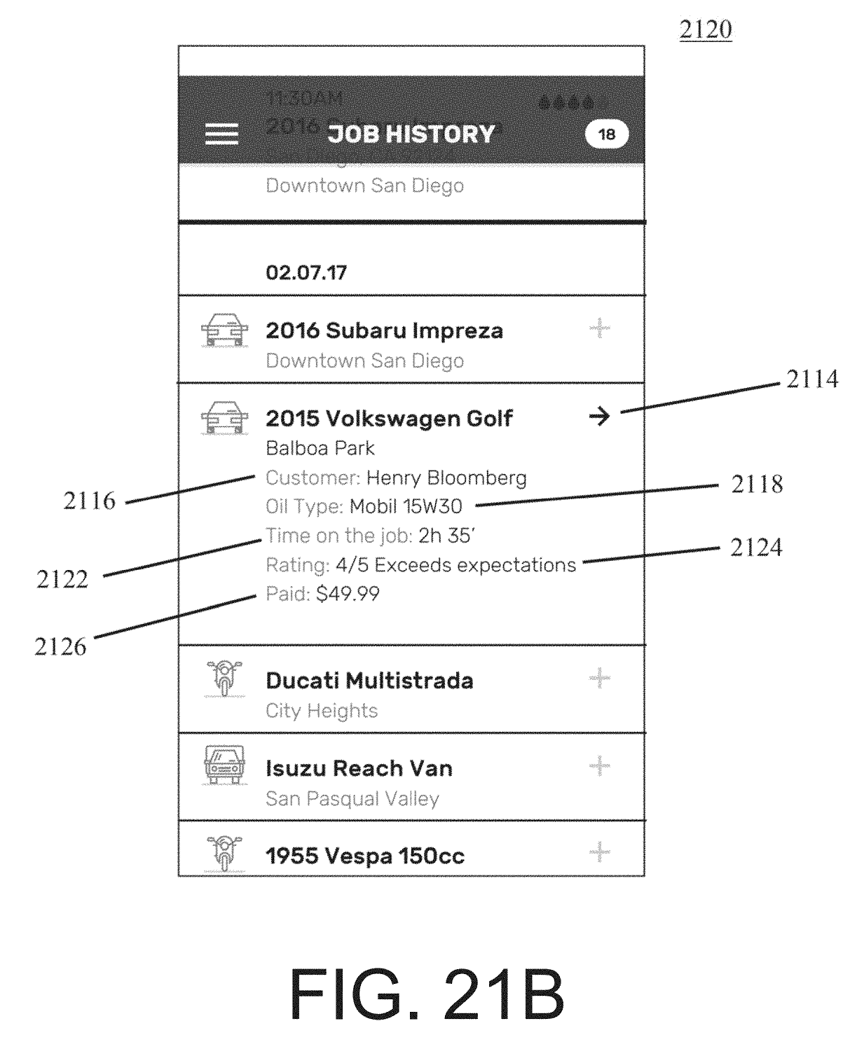

FIGS. 21A-21B show job history screens according to at least one aspect of the present disclosure. FIG. 21A and screen 2100 include rating 2104, sort factor 2102 (that allows the servicer to sort by date or time), job history icon 2106, current date indicator 2108, job entry 2110 showing the vehicle type, make and model as well as the service task location, and expander button 2112. When expander button 2112 is pressed, the view in screen 2120 of FIG. 21B is shown, having customer data 2116, time on the job 2122, amount paid 2126, rating 2124 and oil type 2118 (or another metric used for a service task, such as type of tires replaced, for example). Arrow icon 2114 retracts the entry back to the view shown in FIG. 21A and screen 2100.

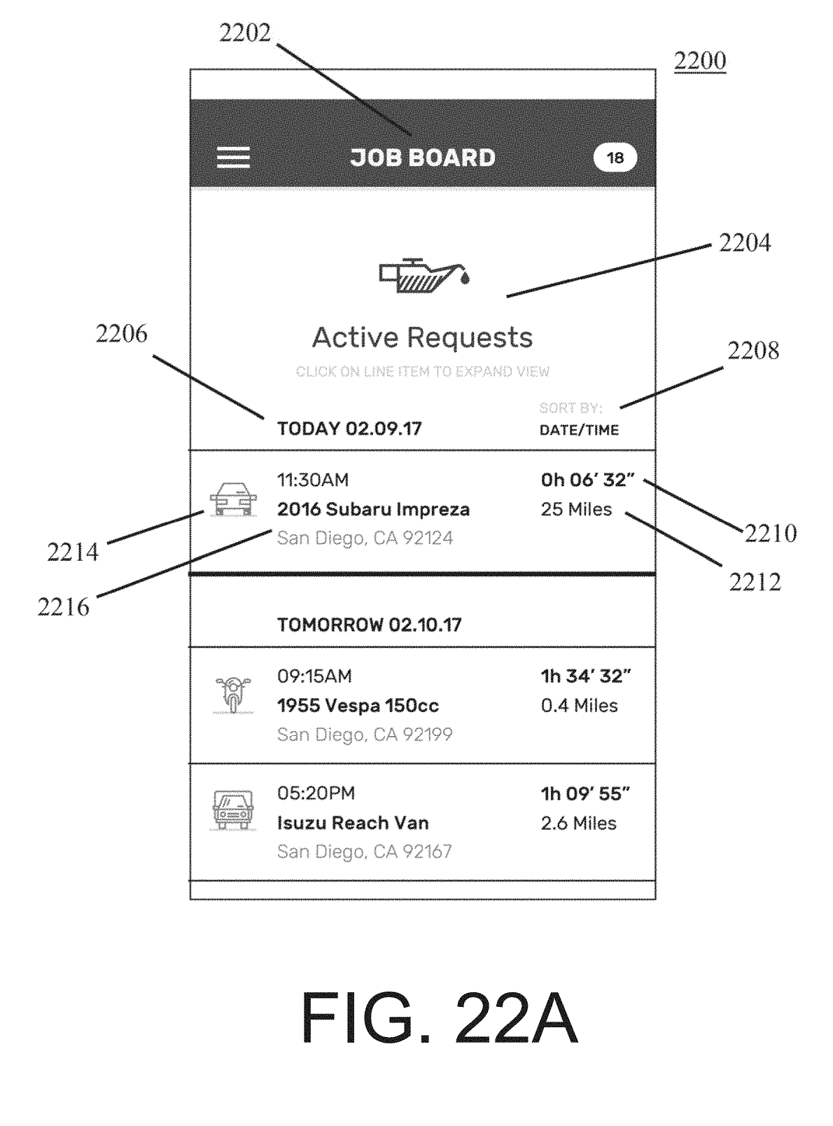

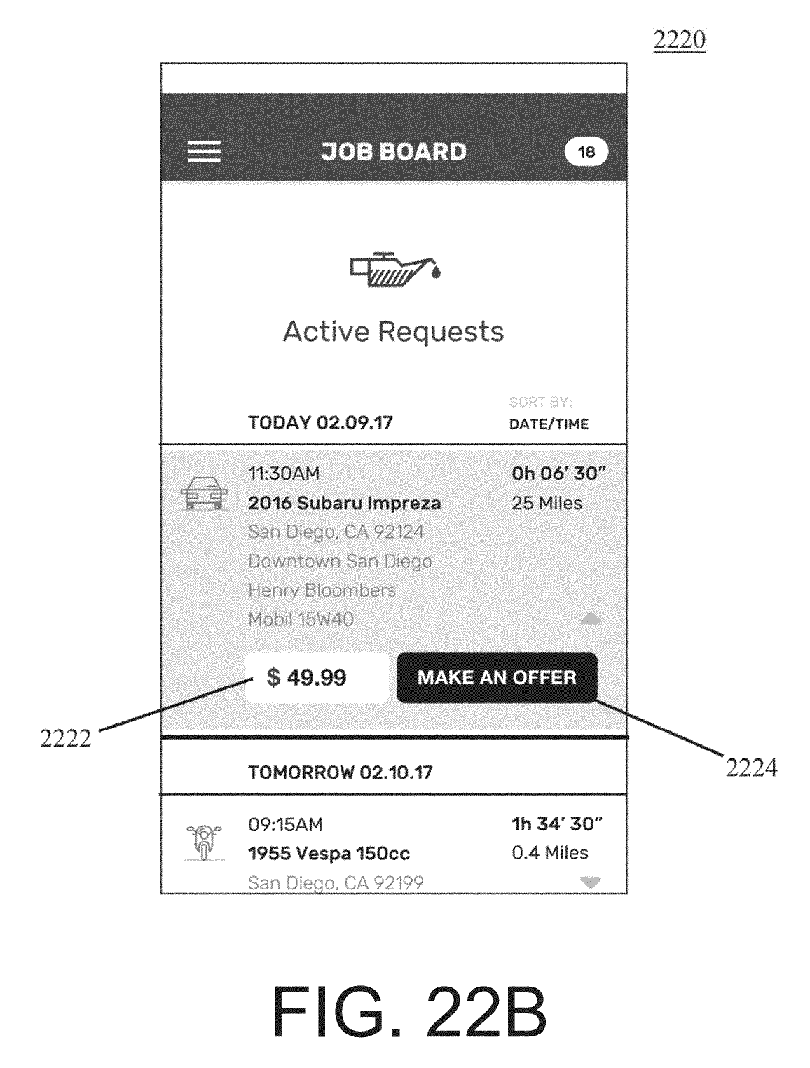

FIGS. 22A-22B show job board screens according to at least one aspect of the present disclosure. FIG. 22A and screen 2200 show a job board with job board text 2202, active request icon 2204, date indicator 2206, date/time sorter 2208 and service task entries including vehicle type 2214, make and model 2216, elapsed time counter 2210, and distance 2212. FIG. 22B and screen 2220 show the servicer able to make an offer by clicking on make an offer button 2224 at offer price 2222 (shown as $49.99).

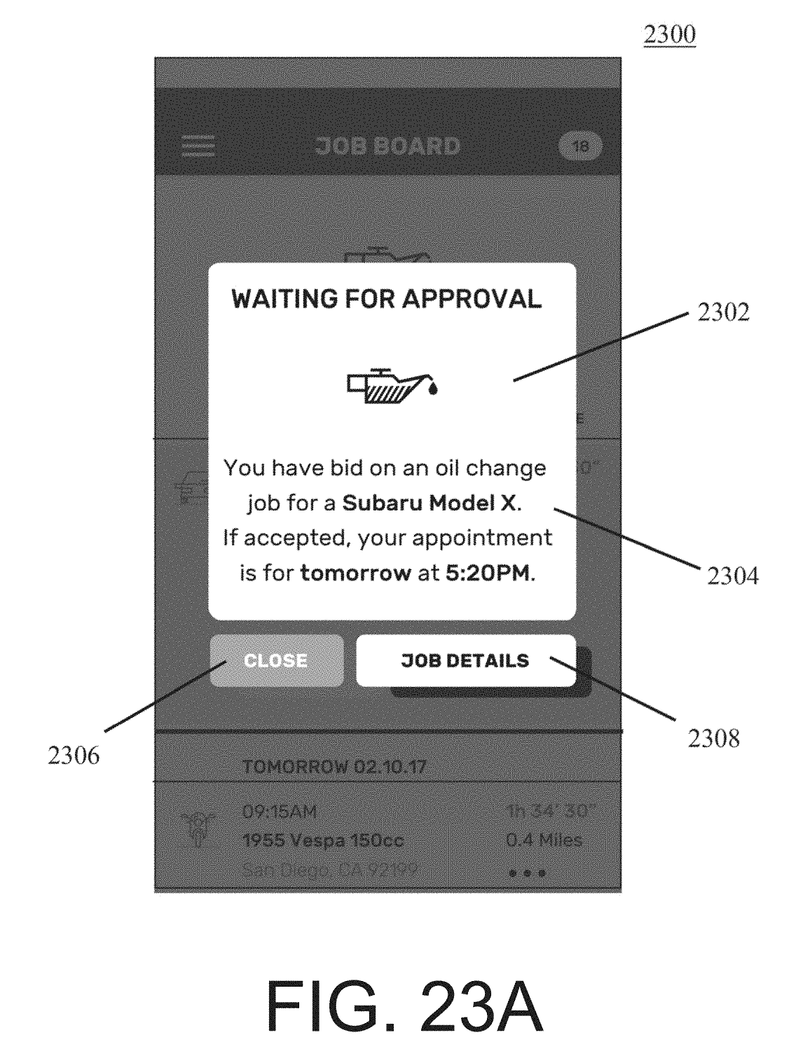

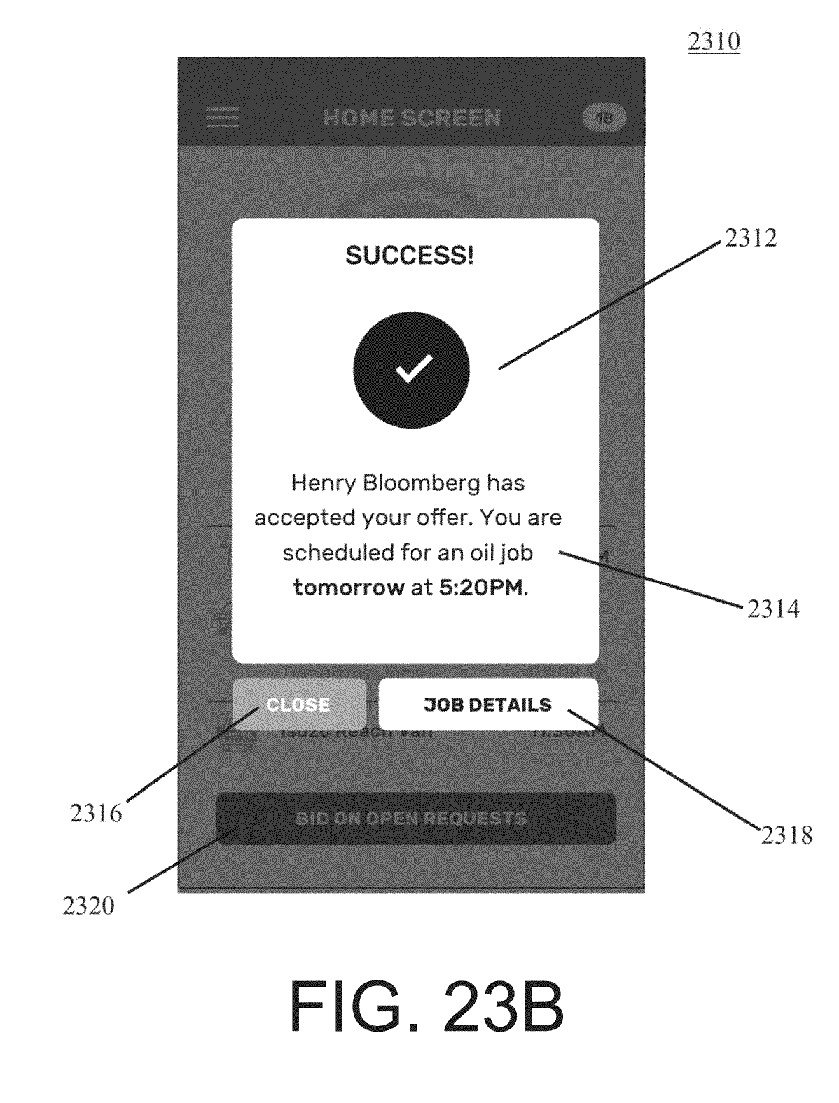

FIGS. 23A-23B show bid screens according to at least one aspect of the present disclosure. In FIG. 23A and screen 2300, a bid has been placed and an oil change job for a selected vehicle is being waited on. Job approval icon 2302 shows what type of service task it is, job approval text 2304 describes that a bid on a service task has been placed, also denoting the time and date of the appointment, close button 2306, if clicked, closes the app and the job details button 2308 brings the servicer back to FIGS. 22A-22B. Screen 2310 of FIG. 23B shows a successful bid with success icon 2312 and successful bid text 2314 indicating the acceptance of an offer as well as the time and date of the service appointment. Close button 2316 closes the screen and brings the servicer back to the home screen. Job details button 2318, if clicked, brings the servicer back to FIGS. 22A-22B.

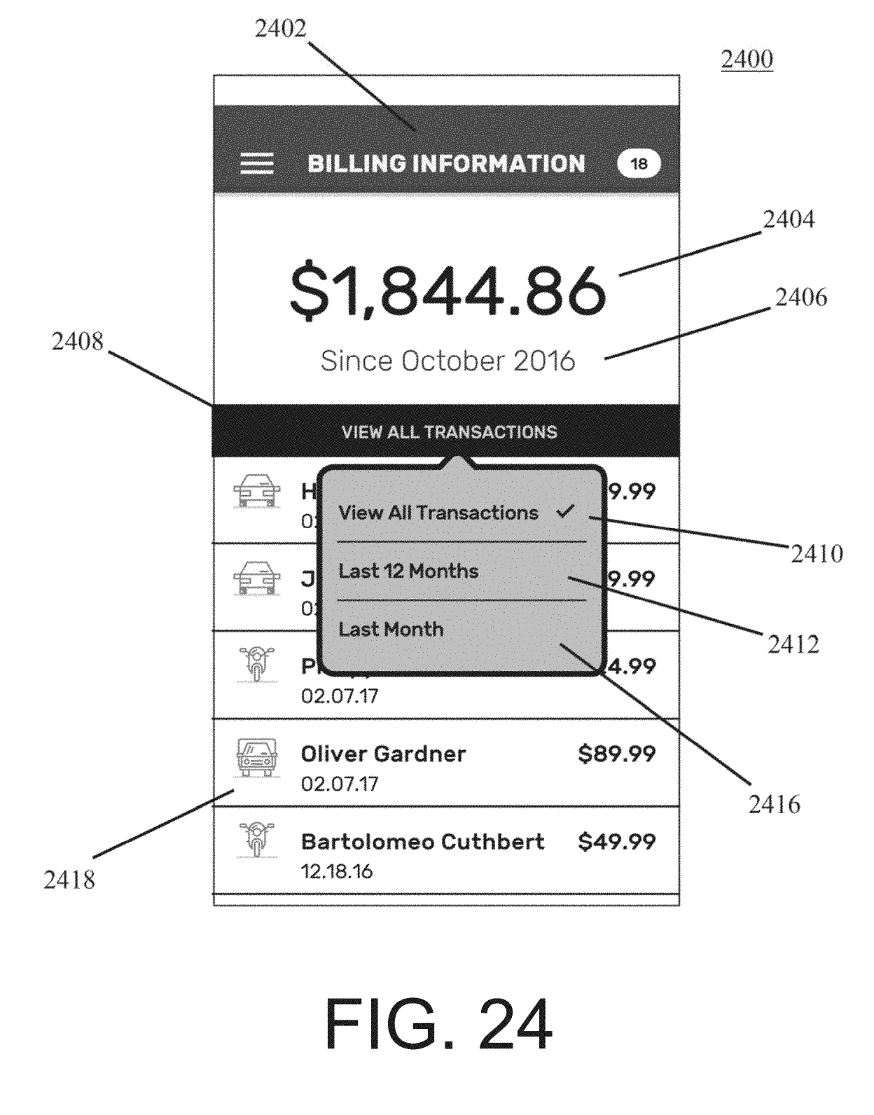

FIG. 24 shows a billing information screen 2400 according to at least one aspect of the present disclosure. Screen 2400 includes billing information text 2402, billing amount 2404, since time billed 2406, view all transactions bar 2408, when clicked, brings up a bubble listing the options of view all transactions 2410, last 12 months 2412 or last month 2416. Transaction entry 2418 shows the vehicle type, name of the requester, price and date of the service task performed.

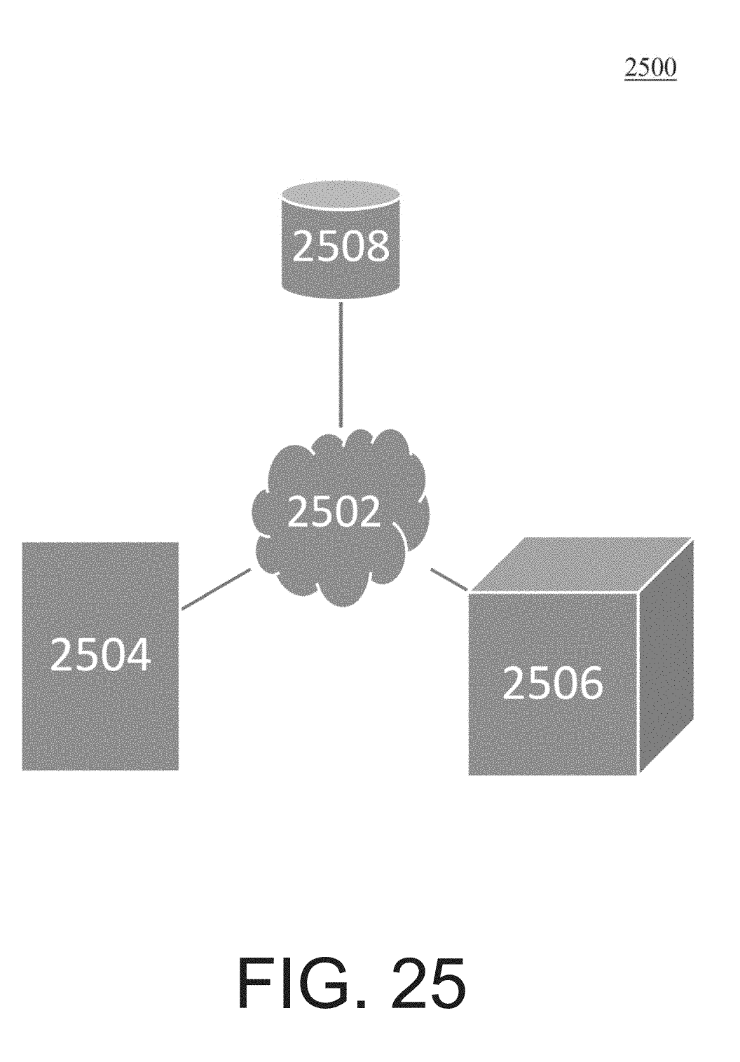

FIG. 25 shows a structural hardware network diagram according to at least one aspect of the present disclosure. Diagram 2500 shows requester device 2504 and servicer device 2506 (either being a smart phone device, computing device, tablet device, or computer) accessing the Internet 2502, along with vehicle service database 2508, which stores all the associated software for the app.

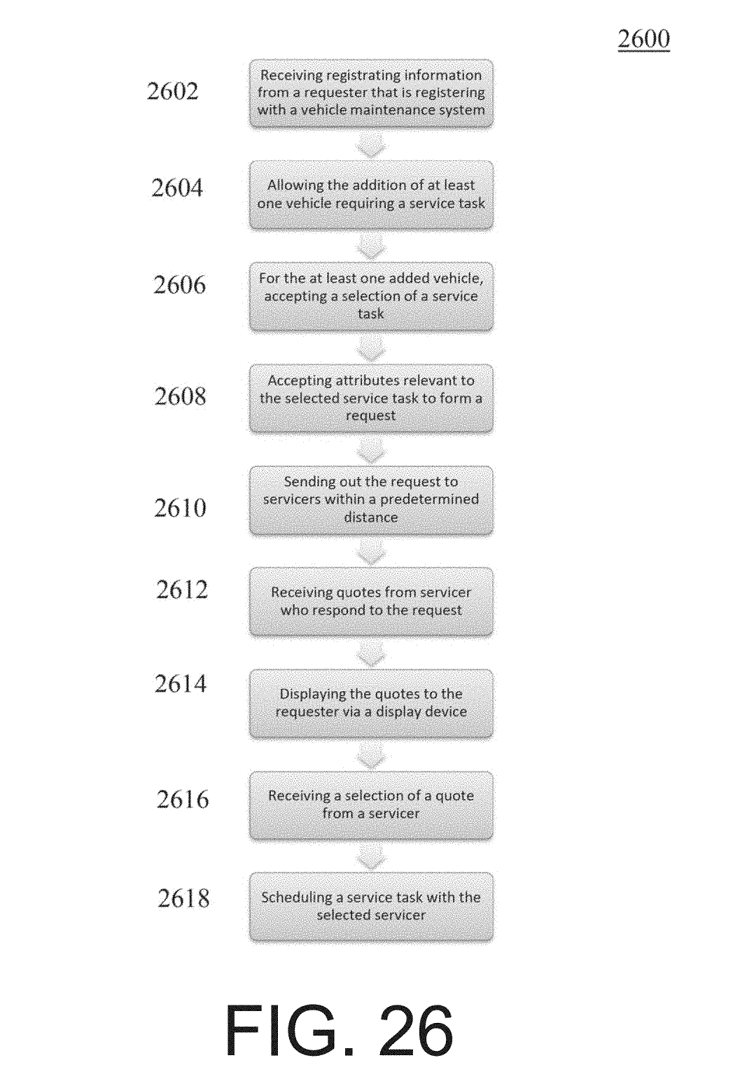

FIG. 26 shows a process flow 2600 according to at least one aspect of the present disclosure. In box 2602, the step performed is receiving registration information from a requester that is registering with a vehicle maintenance system. In box 2604, the step performed is allowing the addition of at least one vehicle requiring a service task. In box 2606, the step performed is for the at least one added vehicle, accepting a selection of a service task. In box 2608, the step performed is accepting attributes relevant to the selected service task to form a request. In box 2610, the step performed is sending out the request to servicers within a predetermined distance. In box 2612, the step performed is receiving quotes from servicers who respond to the request. In box 2614, the step performed is displaying the quotes to the requester via a display device. In box 2616, the step performed is receiving a selection of a quote from a servicer. In box 2618, the step performed is scheduling a service task with the selected servicer.

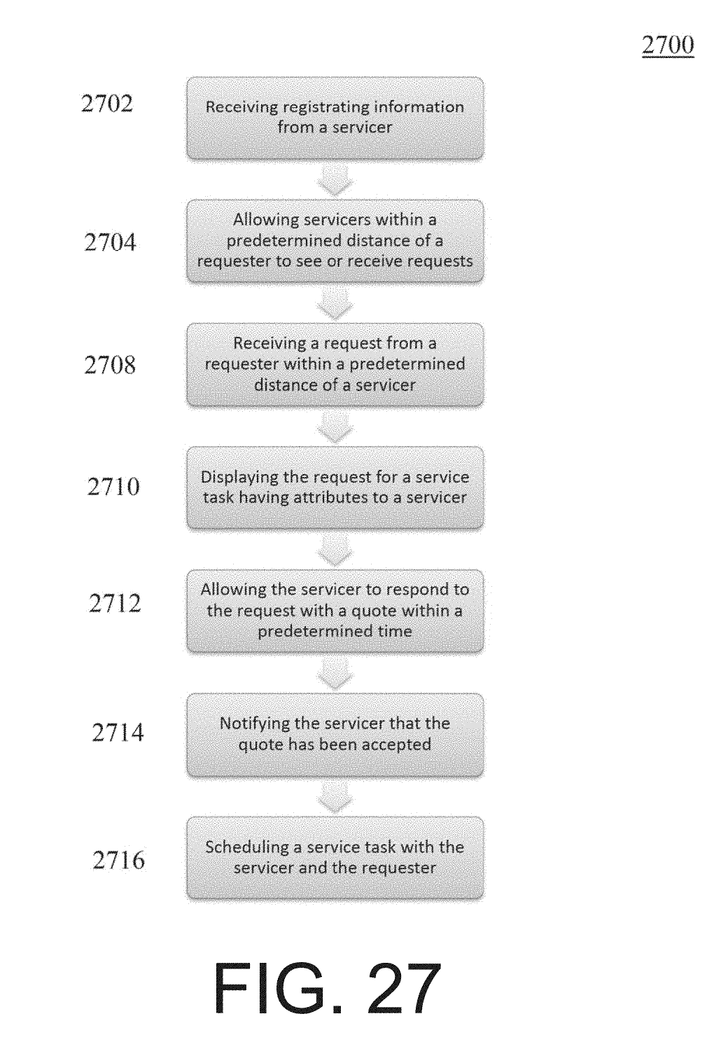

FIG. 27 shows another process flow according to at least one aspect of the present disclosure. In box 2702, the step performed is receiving registration information from a server. In box 2704, the step performed is allowing servicers within a predetermined distance of a requester to see or receive requests. In box 2708, the step performed is receiving a request from a requester within a predetermined distance of a servicer. In box 2710, the step performed is displaying the request for a service task having attributes to a servicer. In box 2712, the step performed is allowing the servicer to respond to the request with a quote within a predetermined time. In box 2714, the step performed is notifying the servicer that the quote has been accepted. In box 2716, the step performed is scheduling a service task with the servicer and the requester.

According to one aspect of the present disclosure, the disclosed vehicle maintenance system enables users or customers to request the installation of devices such as global positioning satellite (GPS) units, on-board diagnostic two (OBDII or OBD-II) specification devices, tablets, speakers, phones, computers installations, audio and visual equipment, sensors, add-ons, diagnostic tools, diagnostic equipment, smart devices, as well as, third party products related to connected car devices and new technology that would improve functionality on cars, trucks, motorcycles boats and planes. Once a user pays for the device (as described above) and a service fee, a technician is deployed to install the device through the software application (“app”) on a mobile or other computing device.

For example, when the disclosed vehicle maintenance systems are working with mechanics and a user wants a new device such as a smart steering wheel (e.g. a steering wheel that has a variety of functions such as measuring driving habits, and has buttons and functionality to control a car stereo and a mobile device from the wheel) the technicians associated with the disclosed vehicle maintenance system will receive and acknowledge this request through a mobile device and the work will be deployed and completed through a smart phone as the communication device.

Another example would be when a user wants a device such as a lane change/collision warning device installed through an app. The company responsible through such a device would put an order through the app having the vehicle maintenance system and a mechanic who has inventory of that device would provide a quote for the price of product and installation. Once agreed upon by user, a technician drives out with the device and installs it.

The disclosed systems and methods are patentable, novel and non-obvious and directed to patentable subject matter because they are directed to communicating a service need for an automobile sea-craft or aircraft, e.g. a mobile oil change. The disclosed systems and methods allows a user to receive what they want via a simpler and more efficient method of requesting a need or want or need via a communication device which brings a result (objective) in faster.

The disclosed systems and methods are also patentable, novel and non-obvious and directed to patentable subject matter because they are directed to communicating a service need for an automobile sea-craft or aircraft, e.g. a mobile oil change. The disclosed systems and methods allows a user to receive what they want or need via a simpler and more efficient method of providing the user with a list of various prices for a service, thus enabling the user to be able to choose in a more timely and efficient fashion the best price for service without having to drive to various service locations or researching though many print and digital advertisements to make a decision.

The disclosed systems and methods are also patentable, novel and non-obvious and directed to patentable subject matter because they are directed to providing a user with a software or software-based tool to record, maintain and track expenditures for vehicle service(s) through a software application, where as they would conventionally have to keep physical paperwork which could deteriorate or get lost easily.

The disclosed systems and methods are also patentable, novel and non-obvious and directed to patentable subject matter because they are directed to allowing a user to assess which service provider provides the most adequate service through a rating system in the context of vehicle service. This bypasses the conventional approach of having to go to multiple service centers and technicians to attain the experience and quality of service after the work is done or having to find articles and reviews or “word of mouth” reviews from others before choosing a technician.

Provided below, without limitation, are also a number of different methods and aspects of the presently disclosed systems and methods. For example, disclosed is:

A method for allowing a person(s) or business(s) registered through the application to schedule a date, time and location anywhere in the world, at any time in the future, for a mobile oil and oil filter change(s) through a smart phone or mobile device.

A method for allowing a person(s) or business(s) registered through the application to choose or input any vehicle make, model, year made, current mileage and license plate number for mechanics, serviceman, or technicians to identify, quote, acknowledge, and complete a person(s) or business(s) or fleet(s) request for a motor oil and oil filter change(s) through a smart phone or mobile device.

A method for allowing vehicle serviceman, mechanic(s) or technician(s) registered through the application to receive one or more requests indicating a local oil change is needed through a smart phone or mobile device.

A method for allowing vehicle serviceman, mechanic(s) or technician(s) registered through the application to review and acknowledge and send back a quote by price in the currency relevant to the location the request is made for an oil change(s) to the original requester(s) of the oil change through a smart phone or mobile device.

A method for allowing a person(s) or business(s) registered through the application to receive, review and accept or reject an offer made in the currency relevant to the location of the request by a vehicle serviceman, mechanic(s) or technician(s) for a motor oil change through a smart phone or mobile device.

A method allowing a person(s) or business(s) registered through the application a specific amount of time to accept or reject a price, offer, or quote from a vehicle serviceman, mechanic(s) or technician(s).

A method for allowing a person(s) or business(s) registered through the application to input the location of their requested oil change so a vehicle serviceman, mechanic or technician can identify and correspond to location, through a smart phone or mobile device.

A method for allowing a vehicle serviceman, mechanic(s) or technician(s) registered through the application to see where they are geographically in transit to the schedule service requested, in real time, through a smart phone or mobile device.

A method to pay for services rendered by a person(s) or business(s) registered through the application in all or any form of digital currencies and bank transaction's capabilities though a smart phone or mobile device.

A method to use a countdown timer to limit the time a vehicle serviceman, mechanic(s) or technician(s) registered through the application can provide a price or quote for the oil change(s) service requested from a person(s) or business(s) registered through the application. The request made by person(s) or business(s) for an oil change disappears after a period of time and must be re-submitted, through a smart phone or mobile device.

A method to allow a person(s), business(s), vehicle serviceman, mechanic(s) or technicians to cancel a scheduled service within a specific period of time through a smartphone or mobile device.

A method to display date and time, as well as, a countdown timer showing both the person(s) or business(s) requesting an oil change, and the vehicle serviceman, mechanic(s) or technician(s) registered through the application, the amount of time until service will begin, through a smart phone or mobile device.

A method showing a person(s) or business(s) when a service by a vehicle serviceman, mechanic(s) or technician(s) registered through the application has been started or finished though a smartphone or mobile device.

A method visually showing a person(s) or business(s) what mechanical procedure or step is being worked on or in progress, in real time, by a vehicle serviceman, mechanic(s) or technician(s) registered through the application, through a smartphone or mobile device.

A method for a person(s) or business(s) to register their name, profile picture, billing information and payment processing information to use the application through a smart phone or mobile device.

A method for vehicle serviceman, mechanic(s) or technician(s) to register their name, profile picture, billing information and payment receipt information through a smart phone or mobile device.

A method allowing a person(s) or business(s) to input a note or any comments or any additional or miscellaneous instructions directed to a vehicle serviceman, mechanic(s) or technician(s) registered through the application, to provide any additional details related to the service, through a smart phone or mobile device.

A method allowing a person(s) or business(s) or vehicle serviceman, mechanic(s) or technician(s) to see the exact time to destination to service before deployment as well as real time GPS coordinates while in transit, through a smart phone or mobile device.

A method allowing a person(s) or business(s) registered through the application to receive a notification indicating a quote, offer or price has been sent to them by a vehicle serviceman, mechanic(s) or technician(s) through a smart phone or mobile device.

A method allowing a vehicle serviceman, mechanic(s) or technician(s) to receive a notification when a request for service is sent by a person(s) or business(s) through a smart phone or mobile device.

A method allowing a person(s) or business(s) registered through the application to receive a notification indicating arrival and start of service by a vehicle serviceman, mechanic(s) or technician(s) through a smart phone or mobile device.

A method allowing a person(s) or business(s) registered through the application to receive a notification indicating a vehicle serviceman, mechanic(s) or technician(s) has departed and in transit to service location through a smart phone or mobile device.

A method allowing a person(s) or business(s) registered through the application to receive a notification indicating a vehicle serviceman, mechanic(s) or technician(s) has completed services through a smart phone or mobile device.

A method allowing a vehicle serviceman, mechanic(s) or technician(s) to receive a notification that their offer, price or quote for a mobile oil change service has been accepted or rejected by a person(s) or business(s) registered through the application through a smart phone or mobile device. Vehicles also include boats, bikes, tanks, planes, drones, motorcycles and so on.

A method allowing a vehicle serviceman, mechanic(s), or technician(s) to receive a notification from a person(s) or business(s) that the service has been cancelled through a smartphone or mobile device.

A method allowing a person(s) or business(s) to receive a notification that a vehicle serviceman, mechanic(s), or technician(s) that the service has been cancelled through a smartphone or mobile device.

A method allowing a person(s) or business(s) registered through the application to receive a notification from the vehicle serviceman, mechanic(s) or technician indicating the stage, progress or step of service the vehicle serviceman, mechanic(s) or technician(s) has started working on, in progress and completed through a smart phone or mobile device.

A method allowing a person(s), business(s), vehicle serviceman, mechanic(s) or technician(s) to registered through the application to receive a notification that payment has been processed for services rendered, through a smart phone or mobile device.

A method for the application to automatically identify and autocomplete the geographic location of a person(s) or business(s) request for service, through a smart phone or mobile device.

A method for the application to automatically autocomplete geographic location of a person(s), business(s), vehicle serviceman, mechanic(s) or technician(s) when registering as a user, through a smart phone or mobile device.

A method for allowing a person(s), business(s), vehicle serviceman, mechanic(s) or technician(s) to contact one another via phone call or sms, through a smart phone or mobile device.

A method allowing a person(s), business(s) to see a history of all or any services provided by a vehicle serviceman, mechanic(s) or technician(s), through a smart phone or mobile device.

A method allowing both a person(s), business(s), vehicle serviceman, mechanic(s) or technician(s) to rate each other for evaluation and quality control purposes, through a smart phone or mobile device.

A method allowing person(s) or business(s) vehicle serviceman, mechanic(s) or technician(s) registered through the application to receive notifications of any promotions, news or updates from our company, through a smart phone or mobile device.

A method allowing a vehicle serviceman, mechanic(s) or technician(s) for generated off services completed to be deposited directly into their bank account, through a smart phone or mobile device.

A method allowing a business or fleet owner to choose one or more of the same vehicles to request an oil change or filter change in bulk to be changed at a specific location anywhere in the world on a specific date and time.

A method allowing a business or fleet owner to choose one or more vehicles to request an oil change or filter change in bulk to be changed at a specific location anywhere in the world on a specific date and time.

Furthermore, the above-disclosed app, and vehicle maintenance systems and methods apply to not only oil changes and other service tasks, but also to brake changes, brake fluid updates, tire rotations, tire replacements, battery replacements, battery installation, battery replacement and installation for hybrid vehicles, general service appointments and check-ups, engine repair, engine upgrades, body work, and other related services tasks, not just for automobiles but also for boats, planes, helicopters, trains, trucks, and related vehicles such as service or fuel such as hybrid vehicles, full electric vehicles, motorcycles, electric bikes, analog bikes, motorcycles, mo-peds, Segways, drones and others.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A computer-implemented method, comprising:
receiving, via a computing device, registration information from a requester that is registering with a vehicle maintenance system;
allowing, via the computing device, the addition of at least one vehicle requiring a service task;
for the at least one added vehicle, accepting, via the computing device, a selection of a service task;
accepting, via the computing device, attributes relevant to the selected service task to form a request;
sending out the request to servicers, via the computing device, within a predetermined distance;
receiving, via the computing device, quotes from servicers who respond to the request;
displaying the quotes to the requester via a display device of the computing device;
receiving, via the computing device, a selection of a quote from a servicer; and
scheduling, via the computing device, a service task with the selected servicer.

2. The method of claim 1, further comprising:
notifying, via the computing device, the acceptance of the quote to both the requester and the servicer.

3. The method of claim 1, wherein the predetermined distance is within twenty miles.

4. The method of claim 1, wherein receiving quotes from servicers who respond to the request includes receiving an acceptance or declination of a quote, via the computing device.

5. The method of claim 1, wherein the service task comprises an oil change, a brake change, a tire rotation, a fueling, a light change.

6. The method of claim 1, wherein the vehicle comprises an automobile, a boat, a helicopter, an airplane, and a motorcycle.

7. A computer-implemented method, comprising:
receiving, via a computing device, registration information from a servicer that is registering with a vehicle maintenance system;
allowing, via the computing device, the viewing of requests from at least one requester by servicers within a predetermined distance
receiving, via the computing device, a request from a requester within the predetermined distance of the servicer;
displaying, via a display device of the computing device, the request for a service task having attributes to the servicer;
allowing, via the computing device, the servicer to respond to the request with a quote within a predetermined time;
notifying, via the computing device, the servicer that the quote has been accepted; and
scheduling, via the computing device, a service task with the servicer and the requester.

8. The method of claim 7, further comprising:
charging, via the computing device, a credit card of the requester after the servicer finishes the service task.

9. The method of claim 7, wherein the predetermined distance is within twenty miles.

10. The method of claim 1, wherein the predetermined time is within 15 minutes.

11. The method of claim 1, wherein the service task comprises an oil change, a brake change, a tire rotation, a fueling, a light change.

12. The method of claim 1, wherein the vehicle comprises an automobile, a boat, a helicopter, an airplane, and a motorcycle.

13. A system for managing and scheduling service tasks for vehicles, comprising:
scheduling hardware circuitry coupled to a database;
at least one requester device; and
at least one servicer device, wherein the scheduling hardware circuitry, the at least one requester device and the at least one servicer device are coupled to the Internet.

14. The system of claim 6, in which the scheduling hardware circuitry registers requesters and servicers and manages requests as well as bids for requesters within a predetermined distance of the servicers.

15. The system of claim 14, wherein the predetermined distance is within twenty miles.

16. The system of claim 13, wherein the scheduling hardware circuitry is configured to receive an acceptance or declination of a quote.

17. The system of claim 13, wherein the service task comprises an oil change, a brake change, a tire rotation, a fueling, a light change.

18. The system of claim 13, wherein the vehicle comprises an automobile, a boat, a helicopter, an airplane, and a motorcycle.

19. The system of claim 13, wherein the schedule hardware circuitry is further configured to charge, via the computing device, a credit card of the requester after the servicer finishes the service task.

20. The system of claim 13, wherein the predetermined time is within 15 minutes.
